(19) United States
(12) Patent Application Publication
(10) Pub. No.: US 2026/0230119 A1
(43) Pub. Date: Aug. 6, 2026

(54) QUASI-ORTHOGONAL SPATIALLY-COUPLED MULTIPLE-INPUT, MULTIPLE-OUTPUT

(71) Applicant: QUALCOMM Incorporated, San Diego, CA (US)

(72) Inventors: Kirill IVANOV, La Jolla, CA (US); Wei YANG, San Diego, CA (US); Jing SUN, San Diego, CA (US); Yu ZHANG, San Diego, CA (US)

(21) Appl. No.: 19/046,049

(22) Filed: Feb. 5, 2025

(51) Int. Cl. H04B 7/0413; H04L 5/00; H04L 27/26

(52) U.S. Cl. CPC H04B 7/0413; H04L 5/0007; H04L 27/2607

(57) ABSTRACT

Various aspects of the present disclosure generally relate to wireless communication. In some aspects, a transmitter may generate multiple code blocks based at least in part on a transport block (TB) segmentation procedure. The transmitter may map the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer. The transmitter may transmit the MIMO transmission based at least in part on the quasi-orthogonal SC-MIMO-based mapping scheme. Numerous other aspects are described.

### FIELD OF THE DISCLOSURE

Aspects of the present disclosure generally relate to wireless communication and specifically relate to techniques, apparatuses, and methods associated with quasi-orthogonal spatially-coupled multiple-input, multiple-output.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a multiple-input, multiple-output (MIMO) system, a transmitter and receiver may simultaneously communicate multiple data streams with one another. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that each antenna of an antenna array transmits respective first signals that, when combined, form the first beam. Similarly, the transmitter may apply a second set of precoding weights to a second signal associated with the second data stream such that each antenna of the antenna array transmits respective second signals that, when combined, form the second beam. In combination, the first signal and the second signal may form a MIMO transmission, and each data stream and/or each signal may be referred to as a layer of the MIMO transmission.

To mitigate recovery errors and/or increase error correction capabilities in a wireless network, raw user data in a data stream may be processed in multiple steps prior to transmission. For instance, the raw user data may first be segmented into a transport block (TB). Channel encoding may be applied to each TB, resulting in a codeword (CW). In some cases, the transmitter may transmit a codeword based at least in part on partitioning the codeword into code blocks, and each code block may be independently processed to apply respective error correction to the code block. With regard to a MIMO transmission, a transmitter may map a codeword (and the corresponding code blocks) to a same MIMO layer or different MIMO layers. To illustrate, based at least in part on a single CW mapping scheme, the transmitter may partition a single CW (CW0) into multiple code blocks, and may partition each code block into multiple code block partitions. The transmitter may then map a respective code block partition to a respective layer of a MIMO transmission.

### SUMMARY

The systems, methods, and devices of this disclosure each have several innovative aspects, no single one of which is solely responsible for the desirable attributes disclosed herein.

Some aspects described herein relate to a method of wireless communication performed by a transmitter. The method may include generating multiple code blocks based at least in part on a transport block (TB) segmentation procedure. The method may include mapping the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer. The method may include transmitting the MIMO transmission based at least in part on the quasi-orthogonal SC-MIMO-based mapping scheme.

Some aspects described herein relate to a method of wireless communication performed by a receiver. The method may include receiving a MIMO transmission that includes N layers, the MIMO transmission being based at least in part on a quasi-orthogonal SC-MIMO-based mapping scheme that is based at least in part on, multiple code blocks being mapped across the N layers such that each layer of the N layers includes a respective portion of the multiple code blocks, and a layer-based cyclical shift of the respective portion of the multiple code blocks for one or more layers of the N layers, N being an integer. The method may include decoding the MIMO transmission based at least in part on the quasi-orthogonal SC-MIMO-based mapping scheme.

Some aspects described herein relate to a transmitter. The transmitter may include a processing system. The processing system may include one or more processors and one or more code-storing memories coupled with the one or more processors. The processing system may be configured to cause the transmitter to generate multiple code blocks based at least in part on a TB segmentation procedure. The processing system may be configured to cause the transmitter to map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer. The processing system may be configured to cause the transmitter to transmit the MIMO transmission based at least in part on the quasi-orthogonal SC-MIMO-based mapping scheme.

Some aspects described herein relate to a receiver. The receiver may include a processing system. The processing system may include one or more processors and one or more code-storing memories coupled with the one or more processors. The processing system may be configured to cause the receiver to receive a MIMO transmission that includes N layers, the MIMO transmission being based at least in part on a quasi-orthogonal SC-MIMO-based mapping scheme that is based at least in part on, multiple code blocks being mapped across the N layers such that each layer of the N layers includes a respective portion of the multiple code blocks, and a layer-based cyclical shift of the respective portion of the multiple code blocks for one or more layers of the N layers, N being an integer. The processing system may be configured to cause the receiver to decode the MIMO transmission based at least in part on the quasi-orthogonal SC-MIMO-based mapping scheme.

Some aspects described herein relate to a non-transitory computer-readable medium that stores a set of instructions for wireless communication by a transmitter. The set of instructions, when executed by one or more processors of the transmitter, may cause the transmitter to generate multiple code blocks based at least in part on a TB segmentation procedure. The set of instructions, when executed by one or more processors of the transmitter, may cause the transmitter to map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer. The set of instructions, when executed by one or more processors of the transmitter, may cause the transmitter to transmit the MIMO transmission based at least in part on the quasi-orthogonal SC-MIMO-based mapping scheme.

Some aspects described herein relate to a non-transitory computer-readable medium that stores a set of instructions for wireless communication by a receiver. The set of instructions, when executed by one or more processors of the receiver, may cause the receiver to receive a MIMO transmission that includes N layers, the MIMO transmission being based at least in part on a quasi-orthogonal SC-MIMO-based mapping scheme that is based at least in part on, multiple code blocks being mapped across the N layers such that each layer of the N layers includes a respective portion of the multiple code blocks, and a layer-based cyclical shift of the respective portion of the multiple code blocks for one or more layers of the N layers, N being an integer. The set of instructions, when executed by one or more processors of the receiver, may cause the receiver to decode the MIMO transmission based at least in part on the quasi-orthogonal SC-MIMO-based mapping scheme.

Some aspects described herein relate to an apparatus for wireless communication. The apparatus may include means for generating multiple code blocks based at least in part on a TB segmentation procedure. The apparatus may include means for mapping the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer. The apparatus may include means for transmitting the MIMO transmission based at least in part on the quasi-orthogonal SC-MIMO-based mapping scheme.

Some aspects described herein relate to an apparatus for wireless communication. The apparatus may include means for receiving a MIMO transmission that includes N layers, the MIMO transmission being based at least in part on a quasi-orthogonal SC-MIMO-based mapping scheme that is based at least in part on, multiple code blocks being mapped across the N layers such that each layer of the N layers includes a respective portion of the multiple code blocks, and a layer-based cyclical shift of the respective portion of the multiple code blocks for one or more layers of the N layers, N being an integer. The apparatus may include means for decoding the MIMO transmission based at least in part on the quasi-orthogonal SC-MIMO-based mapping scheme.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating example code block mapping schemes.

FIG. 4 is a diagram illustrating an example of cyclically-shifted spatially-coupled multiple-input, multiple-output (SC-MIMO).

FIG. 5 is a diagram illustrating a first example of a first code block mapping scheme for code blocks of unequal size and a second example of a quasi-orthogonal SC-MIMO-based mapping for code blocks of unequal size.

FIG. 6 is a diagram illustrating an example of a wireless communication process between a transmitter and a receiver, in accordance with the present disclosure.

FIG. 7 is a diagram illustrating an example process performed, for example, at a transmitter or an apparatus of a transmitter.

FIG. 8 is a diagram illustrating an example process performed, for example, at a receiver or an apparatus of a receiver.

FIG. 9 is a diagram of an example apparatus for wireless communication.

FIG. 10 is a diagram of an example apparatus for wireless communication.

### DETAILED DESCRIPTION

In a multiple-input, multiple-output (MIMO) system, a transmitter and receiver may simultaneously communicate multiple data streams with one another. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that each antenna of an antenna array transmits respective first signals that, when combined, form the first beam. Similarly, the transmitter may apply a second set of precoding weights to a second signal associated with the second data stream such that each antenna of the antenna array transmits respective second signals that, when combined, form the second beam. In combination, the first signal and the second signal may form a MIMO transmission, and each data stream and/or each signal may be referred to as a layer of the MIMO transmission.

To mitigate recovery errors and/or increase error correction capabilities in a wireless network, raw user data in a data stream may be processed in multiple steps prior to transmission. For instance, the raw user data may first be segmented into a transport block (TB). Channel encoding may be applied to each TB, resulting in a codeword (CW). In some cases, the transmitter may transmit a codeword based at least in part on partitioning the codeword into code blocks, and each code block may be independently processed to apply respective error correction and/or append respective cyclic redundancy check (CRC) bits to the code block.

With regard to a MIMO transmission, a transmitter may map a codeword (and the corresponding code blocks) to a same MIMO layer or different MIMO layers. To illustrate, based at least in part on a single CW mapping scheme, the transmitter may partition a single CW (CW0) into multiple code blocks, and may partition each code block into multiple code block partitions. The transmitter may then map a respective code block partition to a respective layer of a MIMO transmission. In some cases, the transmitter may use a spatially-coupled (SC)-MIMO-based mapping scheme to improve a robustness, reliability, and/or data throughput in scenarios where there is significant variation in channel conditions across the MIMO layers. More particularly, an SC-MIMO-based mapping scheme may increase a coupling between MIMO layers using a structured dependency between the layers such that a MIMO layer may be decoded using at least some information from another MIMO layer, as described below. To illustrate, a receiver may use successive interference cancellation (SIC) based at least in part on the structured dependency to improve data recovery for the remaining signal.

Cyclically-shifted SC-MIMO is a type of SC-MIMO-based mapping scheme that may increase a robustness, reliability, and/or data throughput in scenarios where there is significant variation in channel conditions across the MIMO layers. However, the cyclically-shifted SC-MIMO-based mapping scheme may be conditional on each code block and/or each code block resource having the same length, reducing the applicability of cyclically-shifted SC-MIMO in some scenarios. Alternatively, or additionally, the cyclically-shifted SC-MIMO-based mapping scheme may use interference-mitigating code blocks in different layers as described below and, consequently, may be conditional on a user equipment (UE) including support for decoding in multiple directions simultaneously and/or decoding the respective interference-mitigating code block in each layer. The use of an interference-mitigating code block may increase a likelihood that the UE decodes the code block successfully (e.g., without decoding errors or with minimal decoding errors) in a manner that minimizes a potential rate loss. For instance, as described above, an interference-mitigating code block may be transmitted with increased power relative to other code blocks or with a lower MCS to increase the likelihood of a successful decoding, since the interference-mitigating code block may be decoded with the use of SIC. Accordingly, some UEs may not include the decoding capability, also resulting in the reduced applicability of cyclically-shifted SC-MIMO. The reduced applicability of cyclically-shifted SC-MIMO may result in a transmitter being unable to use cyclically-shifted SC-MIMO and, consequently, a reduced robustness, a reduced reliability, and/or reduced data throughput for MIMO transmissions.

Various aspects relate generally to quasi-orthogonal SC-MIMO. Some aspects more specifically relate to an SC-MIMO-based mapping scheme that is based at least in part on a TB size computation procedure, a TB segmentation procedure, or both. In some aspects, a transmitter may generate multiple code blocks based at least in part on a TB segmentation procedure. For example, the transmitter may compute a TB size based at least in part on any combination of equations that results in the transmitter performing a TB segmentation procedure and, subsequently, generating the multiple code blocks for one or more TB segments. The transmitter may map the multiple code blocks across N layers of a MIMO transmission such that each layer of the N layers is assigned a respective portion of the multiple code blocks, N being an integer. Alternatively, or additionally, the mapping may be based at least in part on a quasi-orthogonal SC-MIMO-based mapping scheme that includes a layer-based cyclical shift, such as a layer-based cyclical shift that shifts the respective portion of the multiple code blocks for one or more layers of the N layers. The transmitter may transmit the MIMO transmission based at least in part on the quasi-orthogonal SC-MIMO-based mapping scheme.

In some aspects, a receiver receives a MIMO transmission that includes N layers and the MIMO transmission may be based at least in part on a quasi-orthogonal SC-MIMO-based mapping scheme. The quasi-orthogonal SC-MIMO-based-mapping scheme may map multiple code blocks across the N layers such that each layer of the N layers includes a respective portion of the multiple code blocks, and the mapping may include a layer-based cyclical shift of the respective portion of the multiple code blocks for one or more layers of the N layers. The receiver may decode the MIMO transmission based at least in part on the quasi-orthogonal SC-MIMO-based mapping scheme.

Particular aspects of the subject matter described in this disclosure can be implemented to realize one or more of the following potential advantages. In some examples, by mapping code blocks using a layer-based cyclical shift via a quasi-orthogonal SC-MIMO-based mapping scheme, the described techniques can increase a quantity of scenarios that are applicable to an SC-MIMO-based mapping scheme. That is, a quasi-orthogonal SC-MIMO-based mapping scheme may be applicable to a larger quantity of operating scenarios and/or a larger quantity of UEs relative to using an SC-MIMO-based mapping scheme that does not use the layer-based cyclical shift. The increased applicability and usage of quasi-orthogonal SC-MIMO may increase a robustness, increase a reliability, and/or increase data throughput for MIMO transmissions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

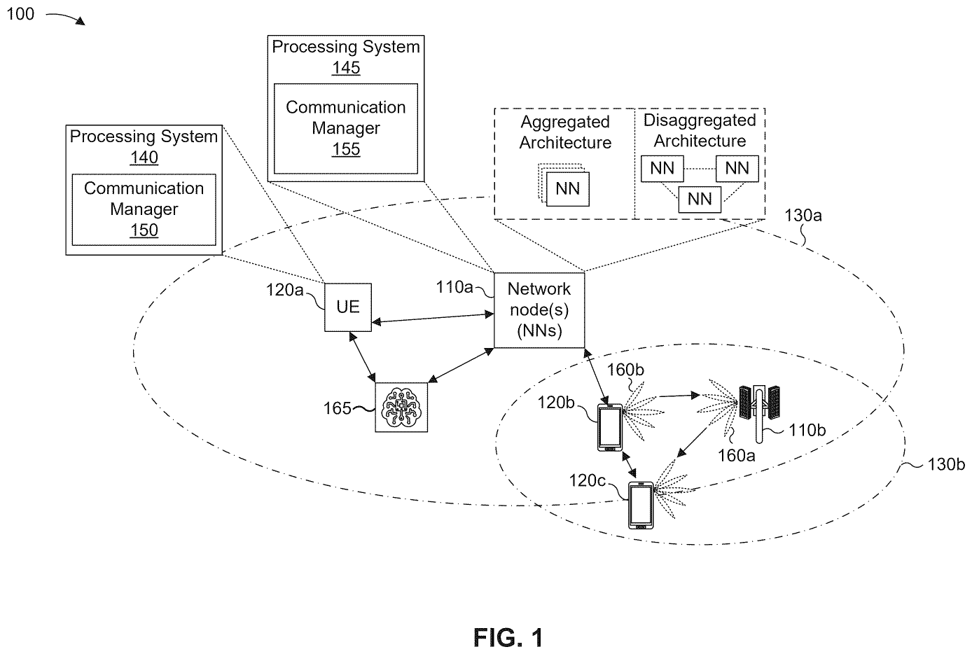

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IOT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams (shown as beams 160a), and a UE 120 may generate one or more beams (shown as beams 160b). The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams and the UE 120 receiving and measuring the signal(s) via respective beams of multiple beams to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi-co-located (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. Based at least in part on the UE being a transmitter, the communication manager 150 may generate multiple code blocks based at least in part on a TB segmentation procedure; map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer; and transmit the MIMO transmission based at least in part on the quasi-orthogonal SC-MIMO-based mapping scheme.

Alternatively, or additionally, based at least in part on the UE being a receiver, the communication manager 150 may receive a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers; and decode the MIMO transmission based at least in part on the quasi-orthogonal SC-MIMO-based mapping scheme. Additionally, or alternatively, the communication manager 150 may perform one or more other operations described herein.

In some aspects, a network node (e.g., a network node 110) may include a communication manager 155. Based at least in part on the network node being a transmitter, the communication manager 155 may generate multiple code blocks based at least in part on a TB segmentation procedure; map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers; and transmit the MIMO transmission based at least in part on the quasi-orthogonal SC-MIMO-based mapping scheme.

Alternatively, or additionally, based at least in part on the network node being a receiver, the communication manager 155 may receive a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers; and decode the MIMO transmission based at least in part on the quasi-orthogonal SC-MIMO-based mapping scheme. Additionally, or alternatively, the communication manager 155 may perform one or more other operations described herein.

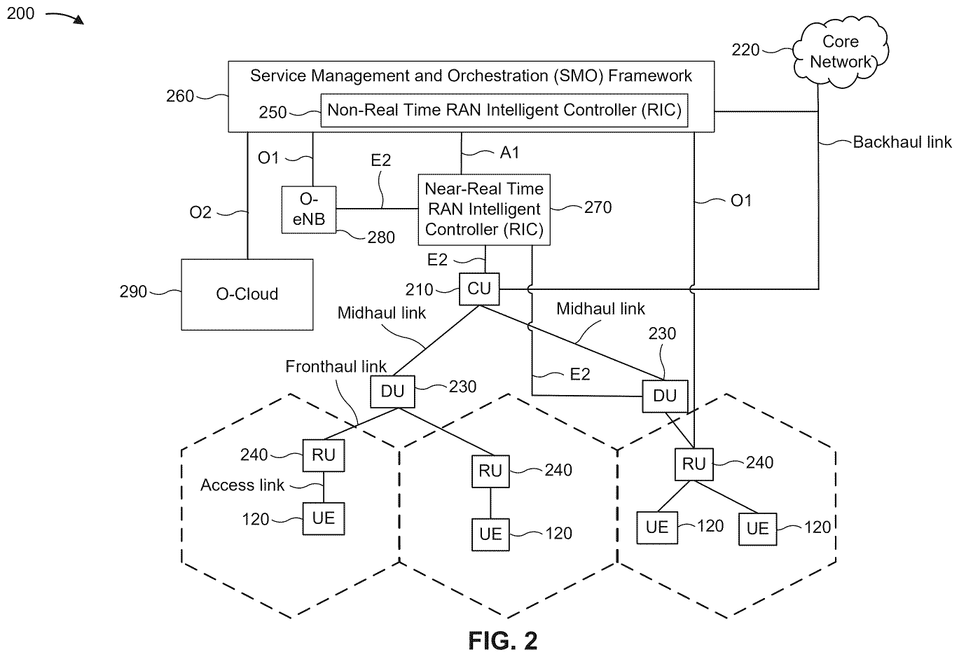

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

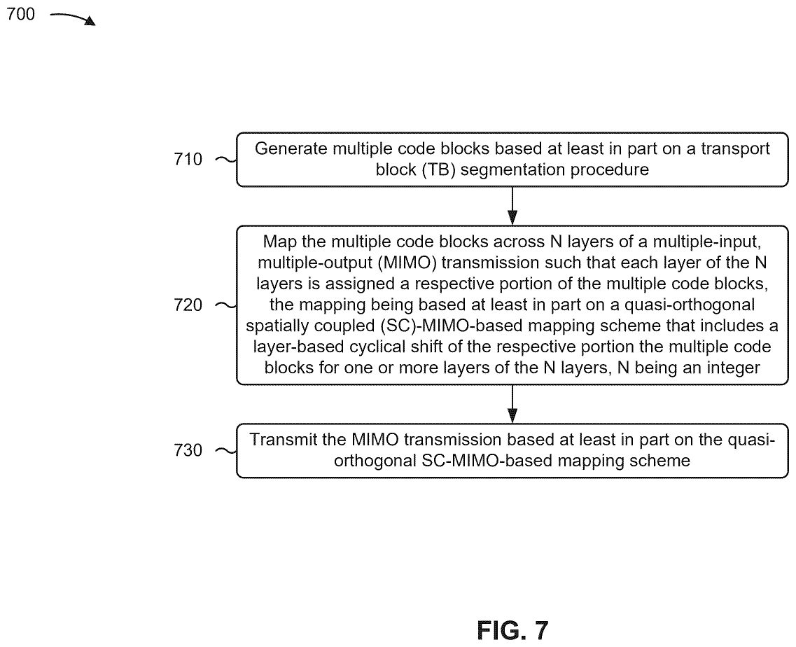

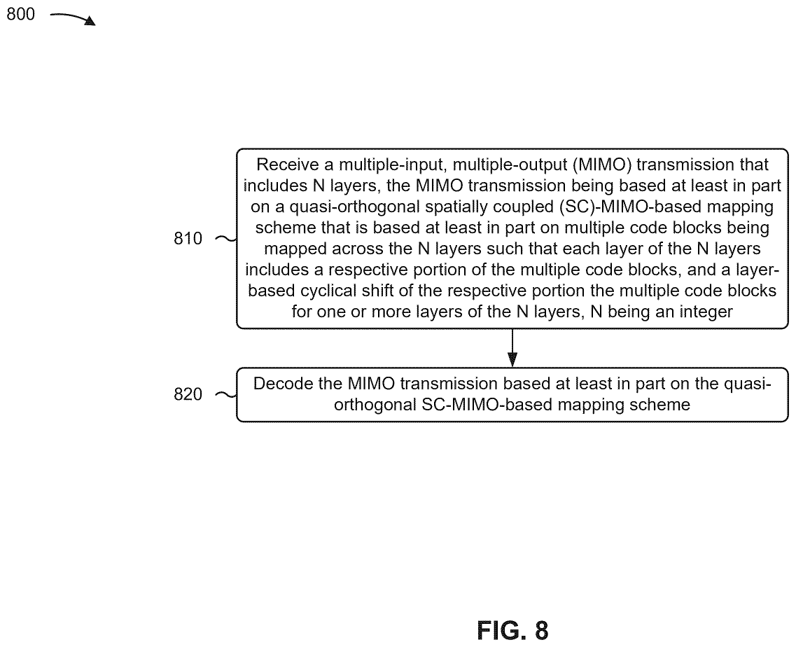

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with quasi-orthogonal SC-MIMO, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

In some aspects, a UE (e.g., a UE 120) may be a transmitter and may include means for generating multiple code blocks based at least in part on a TB segmentation procedure; means for mapping the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer; and/or means for transmitting the MIMO transmission based at least in part on the quasi-orthogonal SC-MIMO-based mapping scheme.

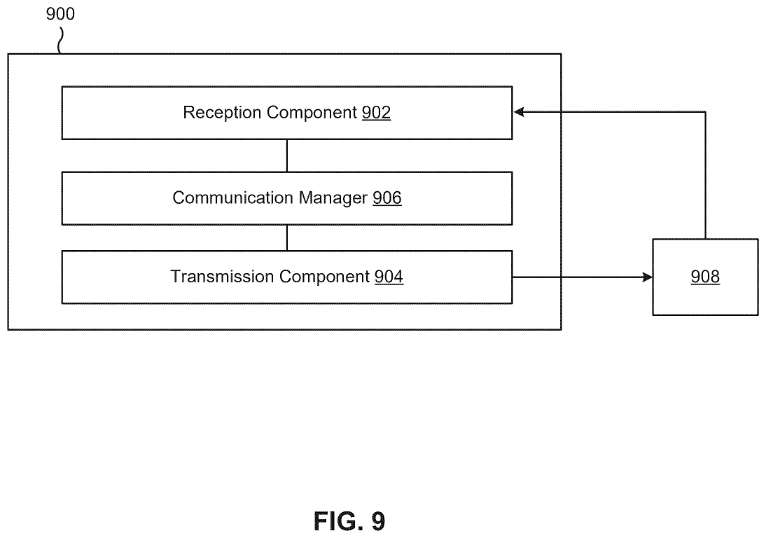

Alternatively, or additionally, the UE may be a receiver and may include means for receiving a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers; and/or means for decoding the MIMO transmission based at least in part on the quasi-orthogonal SC-MIMO-based mapping scheme. In some aspects, the means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a network node (e.g., a network node 110) may be a transmitter and may include means for generating multiple code blocks based at least in part on a TB segmentation procedure; means for mapping the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers; and/or means for transmitting the MIMO transmission based at least in part on the quasi-orthogonal SC-MIMO-based mapping scheme.

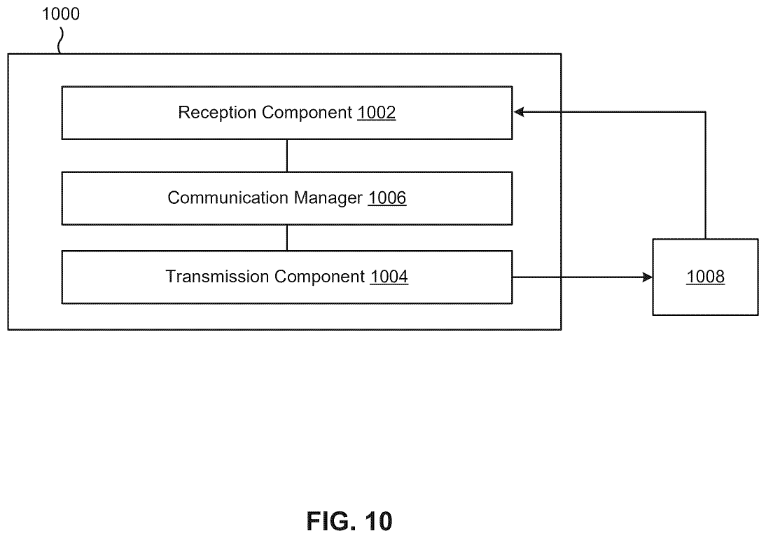

Alternatively, or additionally, the network node may be a receiver and may include means for receiving a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers; and/or means for decoding the MIMO transmission based at least in part on the quasi-orthogonal SC-MIMO-based mapping scheme. In some aspects, the means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

To maintain synchronization and control in communications between a network node and a UE, the network node may schedule resources and transmission parameters that are used by the network node and the UE to transmit and receive a downlink communication or an uplink communication. Example resources and transmission parameters may include a resource block allocation, an MCS, a target power level, and a beamforming configuration. In some cases, the network node may indicate scheduling information (e.g., the scheduled resources or scheduled transmission parameters) to the UE in DCI. For instance, the DCI may include an MCS field, and the network node may set the MCS field to a particular value to indicate the scheduling information. Accordingly, the UE may use the scheduling information to transmit an uplink communication or receive a downlink communication.

As one example, a TB may be a packet of data or a data unit that is sent from a MAC protocol layer to a PHY protocol layer for transmission of user data or control information that is carried in the TB. In some cases, as at least part of a TB size computation procedure, the UE may use the MSC field in DCI to compute a TB size as specified by a communication standard. To illustrate, the communication standard may specify that, based at least in part on the MCS field in DCI being set to a non-reserved value, the UE may compute a TB size using multiple steps. “Non-reserved value” denotes a value or index that may be used by the UE to determine the MCS, and “reserved value” denotes a value or index that is reserved for a specific purpose and is not used for determining the MCS. An example of a TB size computation procedure is described below.

As a first step in computing a TB size based at least in part on the MCS being a non-reserved value, the UE may compute a number of REs (N_{RE}) within a slot of the communication. For instance, the UE may first determine the number of REs allocated for a PDSCH within a PRB (N′_{RE}) using the following equation:

$${N}_{R E}^{′} = {N}_{sc}^{R B} \cdot {N}_{s y m b}^{s h} - {N}_{D M R S}^{P R B} - {N}_{o h}^{P R B} \qquad ( 1 )$$

where

$${N}_{s c}^{R B} = 12$$

is a number of subcarriers in a physical resource block (PRB),

$${N}_{s y m b}^{s h}$$

is a number of scheduled OFDM symbols in a slot,

$${N}_{D M R S}^{P R B}$$

is a number of REs for DMRS per PRB in a scheduled duration of the communication (including an overhead of DMRS code division multiplexing (CDM) groups that are indicated by DCI format 1_0 or DCI format 1_1), and

$${N}_{o h}^{P R B}$$

is the overhead configured by a higher layer parameter (e.g., a HARQ process X identifier (Xₒₕ) for PDSCH (Xoh-PDSCH)). In some aspects, the Xₒₕ-PDSCH may not be explicitly configured (e.g., for an Xₒₕ value, such as 0, 6, 12, or 18) such that the higher layer parameter Xₒₕ-PDSCH is set to 0 by default. The UE may determine a quantized number of REs that are allocated for PDSCH within a PRB (N̅′_{RE}) based at least in part on a value that is computed by the UE using equation (1). For instance, a communication standard may specify a table that includes a first entry that indicates to use a first quantized number of REs (e.g., 6) for any computed value that is less than or equal to 9, a second entry that indicates a second quantized number of REs (e.g., 12) for any computed value that is greater than 9 and less than or equal to 15, and a third entry that indicates a third quantized number of REs (e.g., 18) for any computed value that is greater than 15 and is less than or equal to 30. The UE may then use the quantized value to compute a total number of REs allocated for PDSCH (e.g., N_{RE} by N_{RE}=N̅′_{RE}·N_{PRB}, where N_{PRB} is the total number of allocated PRBs for the UE).

As a second step in computing a TB size based at least in part on the MCS being a non-reserved value, the UE may compute an intermediate number of information bits (N_{info}) using the following equation:

$${N}_{info} = {N}_{R E} \cdot R \cdot {Q}_{m} \cdot υ \qquad ( 2 )$$

where R and Qₘ are a coding rate and modulation order, respectively, that may be determined from the MCS field, and v corresponds to a number of layers in the communication. Based at least in part on N_{info}≤3824, the UE may proceed to a third step in the TB size computation; otherwise, the UE may proceed to a fourth step in the TB size computation.

As a third step in computing a TB size based at least in part on the MCS being a non-reserved value, the UE may compute a quantized number of information bits (N′_{info}) based at least in part on the following equation (e.g., for N_{info}≤3824):

$${N}_{info}^{′} = max ( 24 , {2}^{n} \cdot ⌊ \frac{{N}_{info}}{{2}^{n}} ⌋ ) \qquad ( 3 )$$

where n=max(3, └log₂ (N_{info})┘−6). A communication standard may specify a table that indicates a set of quantized TB sizes, and the UE may select, from the table, a quantized TB size that is closest to, and greater than, N′_{info}.

As a fourth step in computing a TB size based at least in part on the MCS being a non-reserved value, the UE may compute a quantized number of information bits (e.g., N′_{info}) using the following equations (e.g. for, N_{info}>3824):

$${N}_{info}^{′} = {2}^{n} \cdot round ( \frac{{N}_{info} - 24}{{2}^{n}} ) \qquad ( 4 )$$

$$where$$

$$n = ⌊ {log}_{2} ( {N}_{info} - 24 ) ⌋ - 5 \qquad ( 5 )$$

and where ties in the round function are broken toward the next largest integer. Based at least in part on R≤¼, the UE may compute the TB size as:

$$T B S = 8 \cdot C \cdot ⌈ \frac{{N}_{info}^{′} + 24}{8 \cdot C} ⌉ - 24 \qquad ( 6 )$$

$$where$$

$$C = ⌈ \frac{{N}_{info}^{′} + 24}{3816} ⌉ . \qquad ( 7 )$$

Based at least in part on N′_{info}>8424, the UE may compute the TB size as:

$$T B S = 8 \cdot C \cdot ⌈ \frac{{N}_{info}^{′} + 24}{8 \cdot C} ⌉ - 24 \qquad ( 8 )$$

$$where$$

$$C = ⌈ \frac{{N}_{info}^{′} + 24}{8424} ⌉ . \qquad ( 9 )$$

Otherwise, the UE may compute the TB size as:

$$T B S = 8 \cdot ⌈ \frac{{N}_{info}^{′} + 24}{8 \cdot C} ⌉ - 24. \qquad ( 10 )$$

For an MCS field that indicates a reserved value, the UE may compute or derive the TB size using DCI in a latest PDCCH for a same TB using a non-reserved MCS. Based at least in part on there being no PDCCH for the same TB using the non-reserved MCS, and, based at least in part on an initial PDSCH for the same TB being semi-persistently scheduled, the UE may compute or derive the TB size using a most recent semi-persistent scheduling assignment PDCCH. A network node may compute a TB size in a similar manner as the UE and, in some cases, by using information that is local to the network node.

TB segmentation may occur in scenarios in which a TB size exceeds a maximum allowed TB size, which may be specified by a communication standard, resulting in a TB being separated into smaller segments. A variety of factors may affect how the TB is segmented, as well as respective sizes of the segmented TBs, such as a maximum allowed segmented size (e.g., which may be specified by a communication standard or a network operator), a layer count, or a number of RBs that are allocated to the transmission. Alternatively, or additionally, each segment may be partitioned into code blocks, and the code blocks within each segment may have different sizes. For instance, the code block sizes may vary based at least in part on an MCS that is applied to each segment. A network node or a UE may perform a TB segmentation procedure based at least in part on being a transmitter.

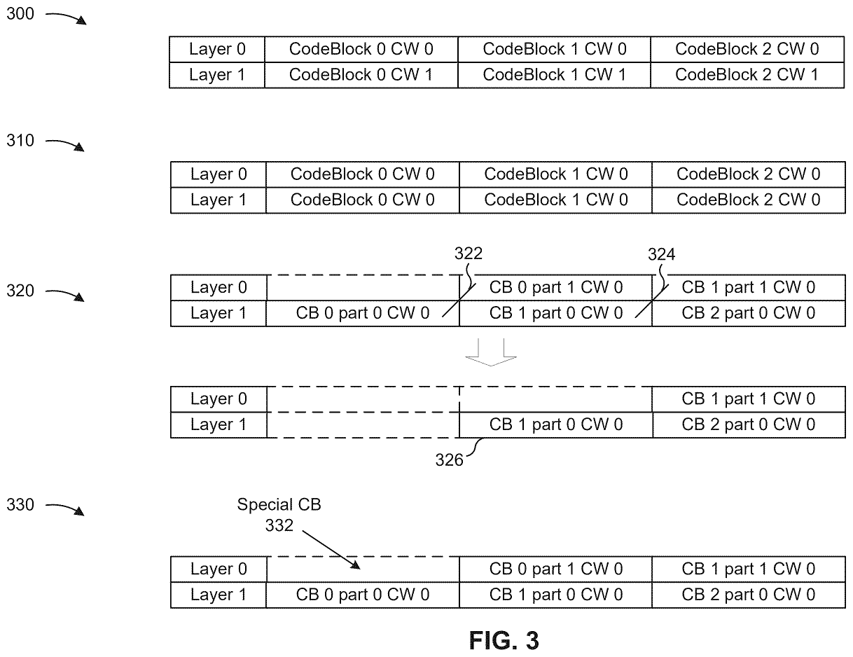

FIG. 3 is a diagram illustrating a first example 300, a second example 310, a third example 320, and a fourth example 330 of code block mapping schemes.

In a MIMO system, a transmitter and receiver may simultaneously communicate multiple data streams with one another. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that each antenna of an antenna array transmits respective first signals that, when combined, form the first beam. Similarly, the transmitter may apply a second set of precoding weights to a second signal associated with the second data stream such that each antenna of the antenna array transmits respective second signals that, when combined, form the second beam. In combination, the first signal and the second signal may form a MIMO transmission, and each data stream and/or each signal may be referred to as a layer of the MIMO transmission. A number and/or quantity of layers in a MIMO transmission may affect data rate and system performance. For instance, more layers enable the MIMO transmission to carry more independent data streams, resulting in an increased overall throughput and/or a decreased data transfer latency.

To mitigate recovery errors and/or increase error correction capabilities in a wireless network, raw user data in a data stream may be processed in multiple steps prior to transmission. For instance, the raw user data may first be segmented into one or more TBs. Channel encoding (e.g., via a polar code, a turbo code, and/or an LDPC) may be applied to each TB, resulting in a codeword (CW). In some cases, the transmitter may transmit a codeword based at least in part on partitioning the codeword into code blocks, and each code block may be independently processed to apply respective error correction and/or append respective cyclic redundancy check (CRC) bits to the code block.

With regard to a MIMO transmission, a transmitter may map a codeword (and the corresponding code blocks) to a same MIMO layer or different MIMO layers. To illustrate, the first example 300 shows a long-term evolution (LTE) dual CW MIMO-based mapping scheme for mapping multiple CWs to multiple layers, such as Layer 0 and Layer 1 of a MIMO transmission. For instance, LTE specifies a first codeword, CW0, as a primary codeword and/or a primary data stream. Single layer transmissions, such as a single-input, single-output (SISO) transmission, always and only carry CW0. LTE also specifies a second codeword, CW1, as a secondary codeword and/or a secondary data stream that is separate and independent of the first codeword CW0. Accordingly, every channel may carry and/or use CW0, and channels that are configured to carry multiple layers, such as PDSCH, may additionally carry CW1 (e.g., for user data). Alternatively, or additionally, MIMO transmissions (e.g., that use spatial multiplexing and/or polarization multiplexing) may carry both CW0 and CW1 in different layers.

The first code block mapping scheme in the first example 300 may be referred to as an LTE dual CW mapping scheme that is based at least in part on time-frequency resources that are allocated to a MIMO transmission. To illustrate, the first example 300 includes two rows of time-frequency resources: a first row of time-frequency resources that are allocated to Layer 0 of the MIMO transmission and a second row of time-frequency resources that are allocated to Layer 1 of the MIMO transmission. The time-frequency resources for each row are partitioned into respective code block resources, and the code block resources may include and/or represent one or more time-frequency resources. To illustrate, a first code block resource in the Layer 0 row (e.g., a first partition) may include and/or represent one or more first time-frequency resources that are allocated to a first portion of a Layer 0 data transmission (e.g., a first code block carried by Layer 0). In a similar manner, a second code block resource in the Layer 0 row (e.g., a second partition) may include and/or represent one or more second time-frequency resources that are allocated to a second portion of the Layer 0 data transmission (e.g., a second code block carried by Layer 0), and the third code block resource in the Layer 0 row (e.g., a third partition) may include and/or represent one or more third time-frequency resources that are allocated to a third portion of the Layer 0 data transmission. A time-frequency resource and, consequently, a code block resource, may be based at least in part on any type of frequency partition and/or any type of time partition, such as a carrier, a sub-carrier, a sub-band, an RB, a resource element (RE), a time slot, a symbol, and/or a mini slot. In some cases, the code block resources between layers may share one or more time-frequency resources based at least in part on a MIMO transmission using a multiplexing scheme (e.g., spatial multiplexing, polarization multiplexing) that separates each layer. Accordingly, a first code block resource in Layer 0 may share one or more time-frequency resources with a first code block resource in Layer 1.

In the LTE dual CW mapping scheme, a transmitter may partition CW0 into a first set of code blocks (shown as CodeBlock 0 CW0, CodeBlock 1 CW0, and CodeBlock 2 CW0), and CW1 into a second set of code blocks (shown as CodeBlock 0 CW1, CodeBlock 1 CW1, and CodeBlock 2 CW1). Based at least in part on using the first code block mapping scheme, the transmitter may assign CW0 to a first layer (e.g., Layer 0) such that each code block of CW0 is mapped to (and subsequently carried by) a respective code block resource of Layer 0. The transmitter may also assign each code block of CW1 to a second layer (e.g., Layer 1) such that each code block of CW1 is mapped to (and subsequently carried by) a respective code block resource of Layer 1. In some cases, the transmitter may use different code rates and/or modulation schemes (e.g., different MCSs) for the Layer 0/CW0 transmission and the Layer 1/CW1 transmission.

A receiver may decode and/or recover CW0 and CW1 based at least in part on using successive interference cancellation (SIC) and/or hard SIC (HSIC). For instance, the receiver may receive a first signal and a second signal as a combined signal, such as Layer 0 and Layer 1 of a MIMO transmission. The receiver may decode the first signal and subtract the first signal from the combined signal to generate a difference signal. The receiver may then decode the difference signal as the second signal. Accordingly, in using SIC to decode and/or recover CW0 and CW1 from the first signal and the second signal, the receiver may iteratively subtract detected signals from a combined signal to improve the detection of the remaining signal (e.g., the difference signal). Using the LTE dual CW mapping scheme of the first example 300 in combination with SIC signal processing may enable a transmitter and receiver to achieve (or approach) a MIMO capacity. Alternatively, or additionally, the receiver may use linear minimum mean squared error (LMMSE) signal processing to improve data recovery (e.g., reduce receiver errors) in decoding the first signal and improve the effectiveness of SIC in subsequent signal decoding. Approaching and/or achieving the MIMO capacity through the use of LTE dual CW mapping may, in some cases, be based at least in part on per-CW CQI feedback having a certain amount of accuracy within a time threshold and/or using separate outer-loop control mechanisms that adjust a target CQI for each CW.

The second example 310 shown by FIG. 3 is a second code block mapping scheme that may be referred to as a single CW mapping with an irregular LDPC and/or as a NR single CW0 mapping scheme. The second code block mapping scheme in the second example 310 may be based at least in part on time-frequency resources that are allocated to a MIMO transmission in a similar manner as described with regard to the first example 300 (e.g., code block resources).

As shown by FIG. 3, a transmitter may partition the single CW0 into multiple code blocks and/or may partition each code block into multiple code block partitions. The transmitter may then map a respective code block partition to a respective layer of a MIMO transmission. For instance, with regard to a 2-layer MIMO transmission, the transmission may assign a first code block partition of a first code block to Layer 0 and a second code block partition of the first code block to Layer 1, which is shown by FIG. 3 as CodeBlock 0 CW0 assigned to Layer 0 and CodeBlock 0 CW0 assigned to Layer 1, respectively. The transmitter may repeat the code block partitioning for each code block of CW0 such that each layer is assigned a respective code block partition of each code block, which is further shown by FIG. 3 as CodeBlock 1 CW0 assigned to Layer 0, CodeBlock 1 CW0 assigned to Layer 1, CodeBlock 2 CW0 assigned to Layer 0, and CodeBlock 2 CW0 assigned to Layer 1.

In the second example 310, each layer transmission may be independent from one another such that a receiver may decode each layer independently and/or without using information from the other layers. Alternatively, or additionally, each layer may be assigned a respective MCS and/or may experience different channel conditions relative to one another. To reduce decoding errors and/or to increase data throughput in a manner that results in a MIMO transmission that approaches and/or achieves a MIMO capacity, a receiver may use non-linear MIMO demodulation techniques, such as iterative SIC, across all of the MIMO layers. However, based at least in part on a transmitter using different MCSs for each layer, a MIMO transmission may deviate from an assumption of uniformly distributed noise (e.g., additive white Gaussian noise (AWGN)). This deviation may make NR LDPC decoding suboptimal for iterative demodulation or decoding processes. Consequently, the NR single CW0 mapping scheme in NR in the second example 310 may be suboptimal relative to an LTE dual CW mapping scheme in some scenarios, such as scenarios in which there is significant channel condition variation across the layers. That is, a MIMO transmission that is based at least in part on LDPC encoding/decoding may achieve higher data throughput using the LTE dual CW mapping scheme relative to the NR single CW 0 mapping scheme in scenarios in which there is significant variation in the channel conditions across the layers.

A transmitter may use spatially-coupled (SC)-MIMO to improve a robustness, reliability, and/or data throughput for LDPC-based MIMO transmissions in scenarios where there is significant variation in channel conditions across the MIMO layers. More particularly, SC-MIMO may use a mapping scheme that increases a coupling between MIMO layers using a structured dependency between the layers such that a MIMO layer may be decoded using at least some information from another MIMO layer, resulting in increased robustness, reliability, and/or data throughput. To illustrate, a single codeword (e.g., CW0) may be partitioned into multiple independent code blocks, and each independent code block may be partitioned into multiple code block partitions. To increase a coupling between MIMO layers, an SC-MIMO-based mapping scheme may use a structured dependency that maps a first code block partition of a first independent code block to a first layer and a second code block partition of a second independent code block to a second layer such that the first code block partition is transmitted simultaneously with the second code block partition via different layers. A receiver may use SIC to subtract the first code block partition from the second code block partition (or vice versa) to improve data recovery for the remaining signal “Spatial coupling” may denote the inter-layer coupling that is based at least in part on the structured dependency.

The third example 320 is an example of a third code block mapping scheme that may also be referred to as an SC-MIMO-based mapping scheme for a single CW0. The third code block mapping scheme shown by FIG. 3 may be based at least in part on the time-frequency resources and/or the code block resources described with regard to the first example 300 and the second example 310. In some aspects, a transmitter using an SC-MIMO-based mapping scheme may select a single CW rate (e.g., a uniform MCS for all layers) to match a collective channel quality across the multiple layers of a MIMO transmission.

In a similar manner as described with regard to the second example 310, a transmitter may partition each code block of a single CW (e.g. CW0) into code block partitions and may map a respective code block partition of each code block to a respective layer of a MIMO transmission. As shown by FIG. 3, the third code block mapping scheme of the third example 320 may be based at least in part on a structured dependency and/or a spatial coupling between the different MIMO layers such that at least a first portion of a first MIMO layer may be decoded using at least some information from a second portion of a second MIMO layer.

To illustrate, as shown by FIG. 3, Layer 0 and Layer 1 may each be assigned three respective code block resources in a similar manner as described above: a first Layer 0 code block resource and a first Layer 1 code block resource, a second Layer 0 code block resource and a second Layer 1 code block resource, and a third Layer 0 code block resource and a third Layer 1 code block resource. Each code block resource may include and/or represent one or more time-frequency resources that are assigned to the respective MIMO layer. In some aspects, a transmitter may map code block partitions of a code block across different MIMO layers using the structured dependency between the code block resources. For instance, based at least in part on a first structured dependency 322, the transmitter may map a first code block partition of a first code word to a first code block resource of Layer 1 (shown as CB 0 part 0 CW0) and a second code block partition of the first code word to a second code block resource of Layer 0 (shown as CB 0 part 1 CW0). Alternatively, or additionally, based at least in part on a second structured dependency 324, the transmitter may map a first code block partition of a second code block to a second code block resource of Layer 1 (shown as CB1 part 0 CW0) and a second code block partition of the second code block (shown as CB1 part 1 CW0) to a third code block resource of Layer 0.

A receiver may decode and/or de-map the information carried in the code block resources (e.g., the code block partitions) based at least in part on the structured dependencies that enable the receiver to use SIC as at least part of a demodulating process and/or a decoding process. For instance, the receiver may begin the decoding process by decoding a first code block (e.g., in the first code block resource of Layer 1 and the second code block resource of Layer 0). Based at least in part on successful decoding, the receiver may subtract the first code block from a composite received signal to obtain a difference signal as shown by reference number 326, and may demodulate and/or decode a second code block using the second code block resource of Layer 1 and the third code block resource of Layer 0. Based at least in part on successful decoding, the receiver may repeat the process of subtracting the most recently decoded signal from the composite received signal and demodulating/decoding the difference signal until all of the code blocks are successfully decoded or a code block decoding failure is declared.

Some mapping schemes for SC-MIMO may include a special code block, which may also be referred to as an interference-mitigating code block, that is designed to enable successful decoding without the use of SIC by a receiver. For instance, an interference-mitigating code block and/or a special code block may be transmitted with a reduced transmit power level and/or with a lower MCS relative to another code block being simultaneously transmitted via another layer. The fourth example 330 shown by FIG. 3 is an example SC-MIMO-based mapping scheme that is similar to the SC-MIMO-based mapping scheme in which the transmitter places a special code block 332 in a code block resource that is linked to a decoding start. For instance, a receiver may begin decoding in a first code block resource of Layer 1 (e.g., CB 0 part 0 CW0) and a second code block resource of Layer 0. To mitigate interference with the first portion of the first code block carried by Layer 1 in the first code block resource, the transmitter may transmit the special code block 332 in a first code block resource of Layer 0 (e.g., simultaneously with the first code block carried by Layer 1). For example, the transmitter may transmit the special code block 332 with a reduced transmit power level relative to a transmission in the first code block resource of Layer 1. Based at least in part on successful decoding of the first code block, the receiver may perform successive decoding based at least in part on SIC in a similar manner as described above. The successive decoding by the receiver may be performed in a single direction (e.g., starting at the first code block resource and ending at the third code block resource), or may be performed in both directions in parallel (e.g., starting at both the first code block resource and the third code block resource). Alternatively, or additionally, a receiver may change a decoding direction based at least in part on observing a decoding failure.

In some aspects, a transmitter may use MIMO layer grouping to increase data throughput and/or reduce data transfer latencies via a MIMO transmission. To illustrate, for multiple layer MIMO transmission, a transmitter may organize the layers into different layer groups in a manner that enables the transmitter to optimize resource allocations, beamforming, and/or spatial multiplexing in a more efficient manner relative to processing each layer independently. With regard to SC-MIMO code block mapping, the structural dependency may be extended to layer groups, rather than individual layers. For instance, each layer in a layer group may carry a respective code block partition of a same independent code block simultaneously. Based at least in part on a structured dependency with the layer groups and/or a structured inter-layer-group coupling, an additional code block partition of the same independent code block may be mapped to a different layer group and/or transmitted at a different time by the different layer group.

As indicated above, FIG. 3 is provided as an example. Other examples may differ from what is described with regard to FIG. 3.

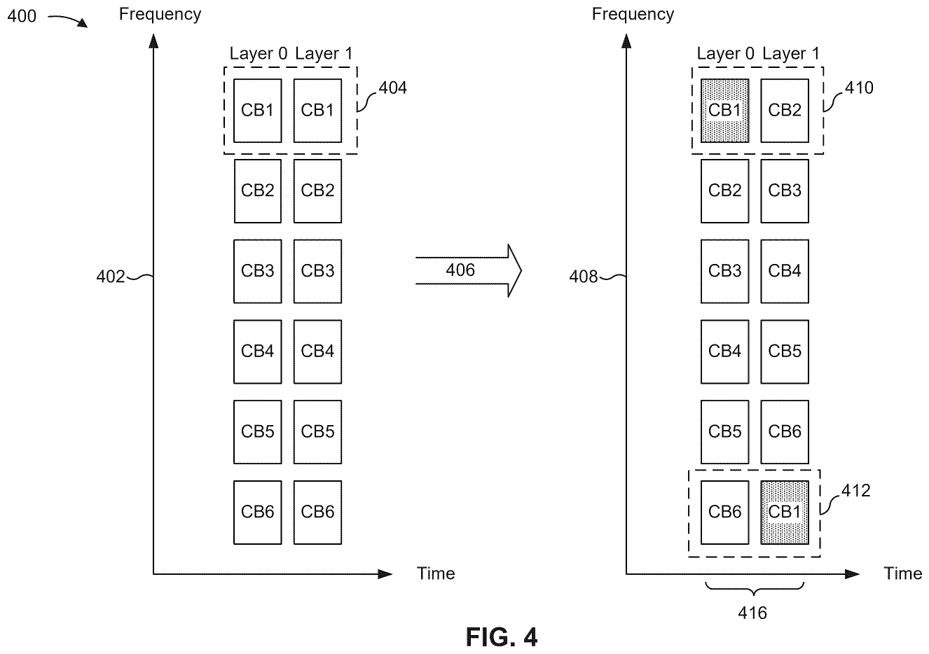

FIG. 4 is a diagram illustrating an example of cyclically-shifted SC-MIMO. The example 400 includes a first mapping scheme 402 in which a horizontal axis represents time and a vertical axis represents frequency. In the first mapping scheme 402, six (6) code blocks are mapped across Layer 0 and Layer 1 of a MIMO transmission in a similar manner as described with regard to FIG. 3. To illustrate, as shown by reference number 404, a first code block 1 (shown as “CB1”) is separated into a first code block partition that is mapped to a first code block resource of Layer 0 and a second code block partition that is mapped to a first code block resource of Layer 1. Each subsequent code block is mapped in a similar manner across Layer 0 and Layer 1.

As shown by reference number 406, a transmitter may apply an SC-MIMO cyclic shift to the first mapping scheme 402 that results in a second mapping scheme 408. A horizontal axis of the second mapping scheme 408 represents time and a vertical axis of the second mapping scheme 408 represents frequency. To apply a cyclic shift to the code block partitions, the transmitter may shift the code block partitions that are mapped to Layer 1 by a code block resource based at least in part on a structured dependency that maps code block partitions of different independent code blocks as described with regard to the third example 320 of FIG. 3. To illustrate, as shown by reference number 410, a first code block partition of a first code block (e.g., CB1) and a second code block partition of a second code block (e.g., CB1) are mapped to a same code block resource index of the transmission such that CB1 and CB2 are transmitted simultaneously. As shown by reference number 412, the cyclic shifting may also result in a second code block partition of the first code block being mapped to a same code block resource index of Layer 1 as a first code block partition of a sixth code block (e.g., CB6). That is, the second code block partition of the first code block may wrap around to the end of the mapping structure (e.g., may wrap around to a last code block index of the MIMO transmission).

In some cases, one or both code block partitions of the first code block may be configured as an interference-mitigating code block, shown by FIG. 4 through the use of a dotted pattern. By configuring both code block partitions of the first code block as interference-mitigating code blocks, a receiver may decode both Layer 0 and Layer 1 in parallel in both directions (e.g., starting at the first code block index of Layer 0 in parallel with the last code block index of Layer 1). The cycle shifting of the SC-MIMO mapping scheme may be based at least in part on the shifting occurring within a same OFDM symbol. For instance, as shown by reference number 416, the code block resources assigned to Layer 0 and the code block resources assigned to Layer 1 may all reside within the same OFDM symbol.

In a similar manner as described with regard to FIG. 3, cyclically-shifted SC-MIMO may increase a robustness, reliability, and/or data throughput for LDPC-based MIMO transmissions in scenarios where there is significant variation in channel conditions across the MIMO layers. However, using cyclically-shifted SC-MIMO may be conditional on each code block and/or each code block resource having the same length, which may reduce the applicability of cyclically-shifted SC-MIMO in some scenarios. To illustrate, a size of a code block may be based at least in part on the TB size computations described above with regard to equations 1-10, a TB segmentation procedure that does not guarantee code blocks of equal size, or both, resulting in code blocks that are ineligible for cyclically-shifted SC-MIMO. Alternatively, or additionally, the second mapping scheme 408 utilizes a respective interference-mitigating code block in each layer to enable decoding, but some UEs may not include capabilities that enable the UE to decode interference-mitigating code blocks in different layers, resulting in the second mapping scheme 408 of cyclically-shifted SC-MIMO being ineligible for some UEs. The inability to use cyclically-shifted SC-MIMO may in result in reduced robustness, reduced reliability, and/or reduced data throughput for LDPC-based MIMO transmissions.

Various aspects relate generally to quasi-orthogonal SC-MIMO. Some aspects more specifically relate to an SC-MIMO-based mapping scheme that is based at least in part on a TB size computation procedure, a TB segmentation procedure, or both. In some aspects, a transmitter may generate multiple code blocks based at least in part on a TB segmentation procedure. For example, the transmitter may compute a TB size based at least in part on any combination of equations 1-10 that results in the transmitter performing a TB segmentation procedure and, subsequently, generating the multiple code blocks for one or more TB segments. The transmitter may map the multiple code blocks across N layers of a MIMO transmission such that each layer of the N layers is assigned a respective portion of the multiple code blocks, N being an integer. Alternatively, or additionally, the mapping may be based at least in part on a quasi-orthogonal SC-MIMO-based mapping scheme that includes a layer-based cyclical shift, such as a layer-based cyclical shift that shifts the respective portion of the multiple code blocks for one or more layers of the N layers. The transmitter may transmit the MIMO transmission based at least in part on the quasi-orthogonal SC-MIMO-based mapping scheme.

In some aspects, a receiver receives a MIMO transmission that includes N layers, and the MIMO transmission may be based at least in part on a quasi-orthogonal SC-MIMO-based mapping scheme. The quasi-orthogonal SC-MIMO-based-mapping scheme may map multiple code blocks across the N layers such that each layer of the N layers includes a respective portion of the multiple code blocks, and the mapping may include a layer-based cyclical shift of the respective portion of the multiple code blocks for one or more layers of the N layers. The receiver may decode the MIMO transmission based at least in part on the quasi-orthogonal SC-MIMO-based mapping scheme.

Particular aspects of the subject matter described in this disclosure can be implemented to realize one or more of the following potential advantages. In some examples, by mapping code blocks using a layer-based cyclical shift via a quasi-orthogonal SC-MIMO-based mapping scheme, the described techniques can increase a quantity of scenarios that are applicable to an SC-MIMO-based mapping scheme. That is, a quasi-orthogonal SC-MIMO-based mapping scheme may be applicable to a larger quantity of operating scenarios and/or a larger quantity of UEs relative to using an SC-MIMO-based mapping scheme. The increased applicability and usage of quasi-orthogonal SC-MIMO may increase a robustness, increase a reliability, and/or increase data throughput for LDPC-based MIMO transmissions.

As indicated above, FIG. 4 is provided as an example. Other examples may differ from what is described with regard to FIG. 4

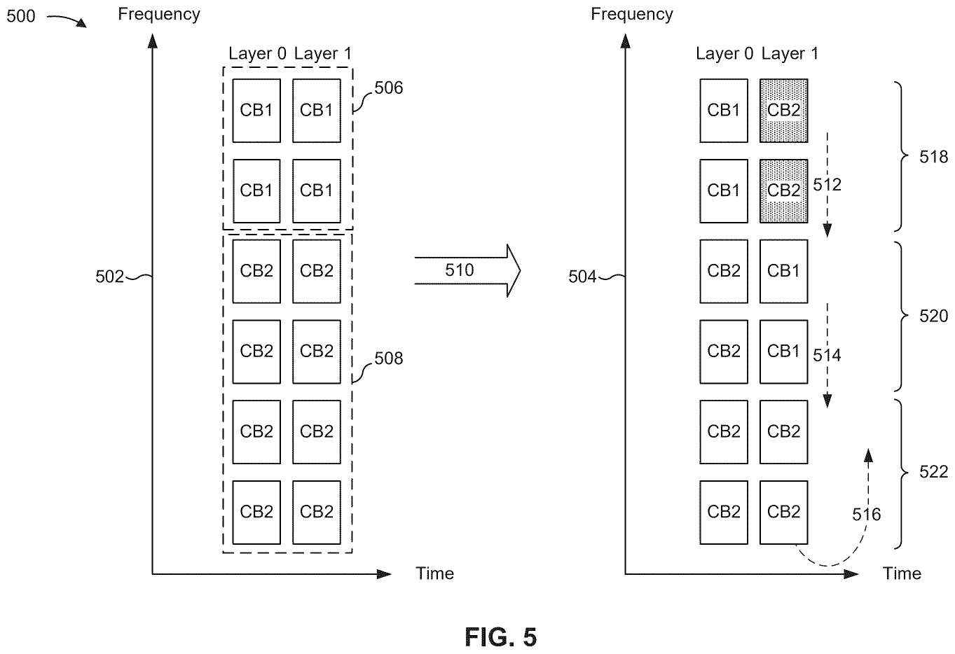

FIG. 5 is a diagram 500 illustrating a first example 502 of a first code block mapping scheme for code blocks of unequal size and a second example 504 of a quasi-orthogonal SC-MIMO-based mapping for code blocks of unequal size.

As described with regard to FIG. 4, a TB size computation procedure, a TB block segmentation procedure, or a combination of the two procedures may result in code blocks of unequal sizes. In the first example 502, a first code block (CB1) and a second code block (CB2) have unequal sizes such that CB1 is separated into four code block partitions and CB2 is separated into eight code block partitions. Using a first code block mapping scheme, CB1 is mapped across Layer 0 and Layer 1 of a 2-layer MIMO transmission to four code block resources in a sequential manner across the layers as shown by reference number 506, where each code block resource may be one or more time-frequency partitions (e.g., one or more REs). In a similar manner, CB2 is mapped across Layer 0 and Layer 1 of the 2-layer MIMO transmission in a sequential manner to eight code block resources as shown by reference number 508. As shown by reference number 510, a transmitter may use a quasi-orthogonal SC-MIMO-based mapping scheme that applies a layer-based cyclical shift to the respective code blocks of one or more layers that shift code blocks relative to the first mapping scheme in the first example 502.

As one example, the transmitter may use one or both of the TB size procedure or TB segmentation procedure described above, and may map the resulting code blocks (which may be of unequal sizes) to the layers of a MIMO transmission using a layer-dependent cyclical shift that shifts the code blocks of Layer i by (i×X) code block resources, such as (i×X) REs, where i and X are respective integers such that the layer-based cyclic shift is an integer multiple (e.g., i) of a shift value (e.g., X). X may be a constant value (e.g., specified by a communication standard) or may be based at least in part on a configuration parameter of a communication being carried by the MIMO transmission, such as a TB size or a code block size (e.g., a first code block size or a last code block). For instance, in the second example 504, X=2. Using the quasi-orthogonal SC-MIMO-based mapping scheme, a transmitter may shift the code blocks of Layer 0 using a shift value of 0×2=0, and may shift the code blocks of Layer 1 using a shift value of 1×2=2. Accordingly, as shown by reference number 512, the code blocks of CB1 mapped to Layer 1 are shifted by two code block resources, and a first portion of the code blocks of CB2 that are mapped to Layer 1 are shifted by two code block resources, as shown by reference number 514. As shown by reference number 516, a last portion of the code blocks of CB2 are cyclically-shifted and mapped to a first code block resource and a second code block resource of Layer 1. The cyclical shift of the quasi-orthogonal SC-MIMO-based mapping scheme may be global (e.g., spans multiple OFDM symbols), or may be a shift within a single OFDM symbol.

In some aspects, the transmitter may configure one or more of the code blocks as interference-mitigating code blocks. To illustrate, as shown by reference number 518 and through the use of a dotted pattern, CB2 in the first code block resource of Layer 1 and CB2 in the second code block resource of Layer 1 may be configured as interference-mitigating code blocks in a similar manner as described with regard to FIG. 3 to increase data recovery at a receiver. That is, the transmitter may include one or more interference-mitigating code blocks at a decoding start location in one or more of the layers, which is shown by FIG. 5 as being at the first code block. While the second example 504 includes interference-mitigating code blocks, alternate examples may not include interference-mitigating blocks. In such an alternate example, a receiver may decode a MIMO transmission based at least in part on an expectation that the MIMO transmission uses an SC-MIMO-based mapping scheme that includes an interference-mitigating code block at a decoding start location (even though the MIMO transmission does not include an interference-mitigating code block). Alternatively, in such an alternate example, a receiver may begin decoding code blocks in the MIMO transmission without an expectation that the MIMO transmission includes an interference-mitigating code block. Based at least in part on decoding a code block successfully, the receiver may continue decoding a remainder of the MIMO transmission with an expectation that the MIMO transmission uses a quasi-orthogonal SC-MIMO-based mapping scheme such that the receiver may use SIC on at least a portion of the MIMO transmission. In some aspects, the receiver may continue to decode code blocks in the MIMO transmission until one of the code blocks is decoded successfully. Based at least in part on decoding a code block successfully, the receiver may begin using SIC using the position of the code block that was decoded successfully as a start of the decoding and the structural dependency of the quasi-orthogonal SC-MIMO-based mapping.

As shown by reference number 520, a portion of the MIMO transmission may include orthogonal code block mappings (e.g., different independent code block portions that are mapped to be transmitted simultaneously via different layers), and the inclusion of orthogonal code block mappings may enable a receiver to use SIC to reduce data recovery errors. In scenarios in which the receiver is a UE, a UE with reduced capabilities (e.g., a UE that does not include support for decoding in multiple directions simultaneously) may decode the MIMO layers using the reduced capabilities, thus increasing the applicability of the quasi-orthogonal SC-MIMO-based mapping scheme.

In some cases, as shown by reference number 522, the quasi-orthogonal SC-MIMO-based mapping scheme may result in some code block pairings (e.g., between layers) that are not orthogonal and may include code block portions from a same independent code block (shown as CB2). The non-orthogonal code block pairings may result in a receiver being unable to use SIC for decoding for the non-orthogonal code block pairings. However, a first percentage of non-orthogonal code block pairings in the MIMO transmission may be small enough (e.g., may satisfy a small threshold) such that a second percentage of orthogonal code block pairings is larger than the first percentage and the receiver may use SIC for a majority of decoding the MIMO transmission, resulting in reduced recovery errors and increased data throughput. In some cases, the receiver may autonomously decide whether to use SIC as part of the decoding process without notifying the transmitter.

While the second example 504 of FIG. 5 shifts code blocks by layer, other examples may include layer-group-based shifts. To illustrate, the code blocks of layer group i may be shifted by i×X code block resources, such that the code blocks of each layer in the layer group are collectively shifted by i×X code block resources. In a similar manner as described above, X may be a constant value (e.g., specified by a communication standard) or may be based at least in part on a configuration parameter of a communication being carried by the MIMO transmission.

Alternatively, or additionally, while the second example 504 shifts the code blocks of a 2-layer MIMO transmission, aspects of the second example 504 may be used by the transmitter for MIMO transmissions with more than two layers. For instance, for MIMO transmissions with more than two layers, the transmitter may apply the quasi-orthogonal SC-MIMO-based mapping based at least in part on two codewords. To illustrate, a MIMO transmission may include N layers, where Nis an integer that is greater than two. As a first example, the transmitter may split the N layers into halves (e.g., a first group of N/2 layers and a second group of N/2 layers) and may apply quasi-orthogonal SC-MIMO-based mapping to each grouping of layers, such as by mapping a first codeword to the first group of N/2 layers (e.g., a pair of layers for N/2=2 or groups of layers for N/2>2) and mapping a second codeword to the second group of N/2 layers. That is, the transmitter may map a first set of code blocks that are associated with the first codeword across the first group of N/2 layers using the quasi-orthogonal SC-MIMO-based mapping scheme and may map a second set of code blocks that are associated with the second codeword across the second pair of layers using the quasi-orthogonal SC-MIMO-based mapping scheme. The transmitter may map the first codeword and the second codeword independently from one another. As a second example, the transmitter may map both codewords across all of the N layers based at least in part on using subsets of time-frequency resources for each codeword. For instance, the transmitter may map the first set of code blocks across the N layers of the MIMO transmission using a first subset of code block resources out of an entirety of code block resources allocated to the MIMO transmission (e.g., using a quasi-orthogonal SC-MIMO based mapping scheme). The transmitter may also map the second set of code blocks across the N layers of the MIMO transmission using a second subset of code block resources out of the entirety of code block resources that are allocated to the MIMO transmission (e.g., using a quasi-orthogonal SC-MIMO based mapping scheme), where the second subset of code block resources are different from the first subset of code block resources. The mapping across the first subset of code block resources and the second subset of code block resources may be independent from one another and, as described above, a code block resource may be one or more time-frequency resources, such as an RE.

A quasi-orthogonal SC-MIMO-based mapping scheme may be applicable to a larger quantity of operating scenarios and/or a larger quantity of UEs relative to using an SC-MIMO-based mapping scheme that does not use the layer-based cyclical shift. The increased applicability and usage of quasi-orthogonal SC-MIMO may increase a robustness, increase a reliability, and/or increase data throughput for LDPC-based MIMO transmissions.

As indicated above, FIG. 5 is provided as an example. Other examples may differ from what is described with regard to FIG. 5.

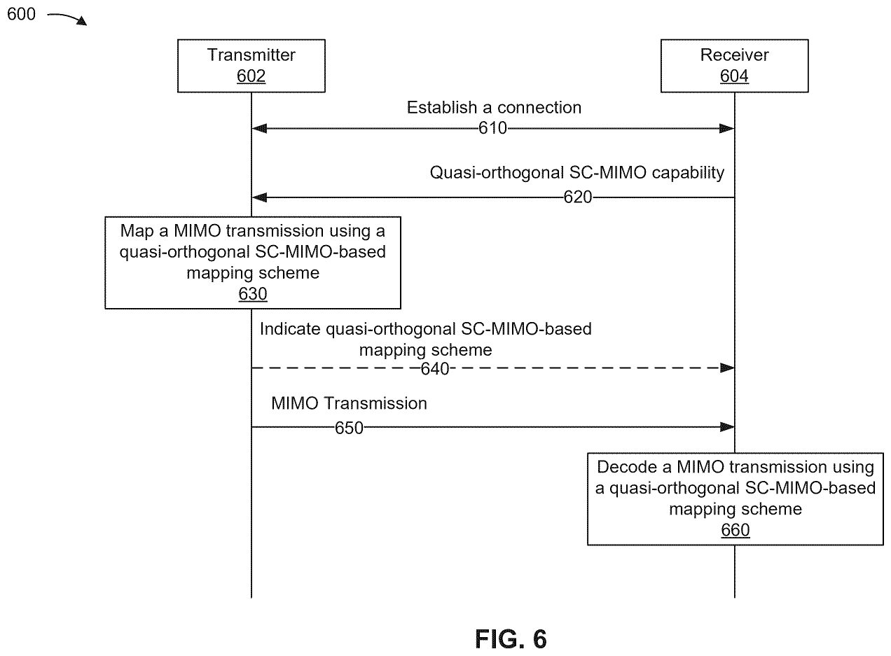

FIG. 6 is a diagram illustrating an example 600 of a wireless communication process between a transmitter 602 (e.g., a network node 110 or a UE 120) and a receiver 604 (e.g., a UE 120 or a network node 110), in accordance with the present disclosure. The transmitter 602 may transmit and/or receive communications with the receiver 604, and the receiver 604 may transmit and/or receive communications with the transmitter 602. In the example 600, the transmitter 602 is a first wireless communication device that performs quasi-orthogonal SC-MIMO-based mapping for MIMO transmissions that include more than two layers (or more than two layer groups) as described with regard to FIG. 5, and the receiver is a second wireless communication device that performs decoding based at least in part on the quasi-orthogonal SC-MIMO-based mapping as described with regard to FIG. 5. However, the transmitter 602 may also include quasi-orthogonal SC-MIMO-based decoding functionality as described with regard to the receiver 604, and/or the receiver 604 may include quasi-orthogonal SC-MIMO-based mapping functionality as described with regard to the transmitter 602.

As shown by reference number 610, a transmitter 602 and a receiver 604 may establish a connection. To illustrate, the receiver 604 may be a UE 120 that powers up in a cell coverage area provided by a network node 110 that operates as the transmitter 602, and the receiver 604 and the transmitter 602 may perform one or more procedures (e.g., a random access channel (RACH) procedure and/or an RRC procedure) to establish a wireless connection. As another example, the receiver 604 (e.g., as a UE 120) may move into the cell coverage area provided by the transmitter 602 (e.g., as a network node 110) and may perform a handover from a source network node to the transmitter 602. Alternatively, or additionally, the transmitter 602 and the receiver 604 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the transmitter 602 may request, via RRC signaling, capability information and/or the receiver 604 may transmit, via RRC signaling, the capability information. As part of communicating via the connection, the transmitter 602 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the transmitter 602 may transmit the configuration information via Layer 3 signaling at a first point in time associated with the receiver 604 being tolerant of communication delays, and the transmitter 602 may transmit an activation of the configuration via Layer 2 signaling and/or Layer 1 signaling at a second point in time associated with the receiver 604 being less tolerant to communication delays.

As shown by reference number 620, the receiver 604 may transmit, and the transmitter 602 may receive, an indication of a quasi-orthogonal SC-MIMO capability. For instance, the receiver 604 may indicate support for a quasi-orthogonal SC-MIMO-based mapping scheme for MIMO transmissions that include more than two layers or more than two layer groups, such as the second example 504 described with regard to FIG. 5.

For clarity, FIG. 6 illustrates the receiver 604 transmitting the indication of the quasi-orthogonal SC-MIMO capability in a separate transaction than establishing a connection with the transmitter 602. However, in some aspects, the receiver 604 may transmit the indication of the quasi-orthogonal SC-MIMO capability as part of establishing a connection with the receiver 604.

As shown by reference number 630, the transmitter 602 may map a MIMO transmission using a quasi-orthogonal SC-MIMO-based mapping scheme, such as the quasi-orthogonal SC-MIMO-based mapping scheme described with regard to FIG. 5. For instance, the transmitter 602 may generate a TB based at least in part on computing a TB size (e.g., using a TB size computation procedure). Alternatively, or additionally, the transmitter 602 may segment the TB based at least in part on a TB segmentation procedure. The transmitter may use a TB size computation procedure or a TB segmentation procedure (or both) that does not guarantee that each code block of the multiple code blocks has a same size, such as the TB size computation procedure and the TB segmentation procedure described above. The transmitter may separate each TB or each TB segment into multiple code blocks.

The transmitter may map the multiple code blocks across N layers of a MIMO transmission such that each layer of the N layers is assigned a respective portion of the multiple code blocks. The quasi-orthogonal SC-MIMO-based mapping scheme may use a respective layer-based cyclical shift of the respective portion of the multiple code blocks for one or more layers of the N layers. Examples of layer-based cyclical shift may include a layer-dependent cyclical shift or a layer-group-dependent cyclical shift as described with regard to FIG. 5. In some cases, the transmitter 602 may include one or more interference-mitigating code blocks at a decoding start location in at least one MIMO layer of the N layers.

The MIMO transmission may include at least four layers. In such a scenario, the transmitter 602 may map two codewords across the four layers such that the multiple code blocks described above include a first set of code blocks that are associated with a first codeword and a second set of code blocks that are associated with a second codeword. To map the multiple code blocks, the transmitter 602 may group the N layers into at least a first pair of layers and a second pair of layers, and may perform the mapping by mapping the first set of code blocks across the first pair of layers using the quasi-orthogonal SC-MIMO-based mapping scheme and the second set of code blocks across the second pair of layers using the quasi-orthogonal SC-MIMO-based mapping scheme. The transmitter 602 may map the first set of code blocks independently from the second set of code blocks is independent from mapping the first set of code blocks. Alternatively, the transmitter 602 may map the first set of code blocks across the N layers using a first subset of code block resources that are allocated to the MIMO transmission and may map the second set of code blocks across the N layers of the MIMO transmission using a second subset of code block resources that are allocated to the MIMO transmission and are different from the first subset of code block resources. As described above, the code block resources may be one or more time-frequency resources, such as one or more REs.

As shown by reference number 640, the transmitter 602 may transmit, and the receiver 604 may receive, an indication of the quasi-orthogonal SC-MIMO-based mapping scheme. For example, the transmitter 602 may transmit an indication that a MIMO transmission uses a quasi-orthogonal SC-MIMO-based mapping scheme using Layer 1 signaling, Layer 2 signaling, Layer 3 signaling, or any combination thereof. While FIG. 6 illustrates the transmitter 602 transmitting the indication of the quasi-orthogonal SC-MIMO-based mapping scheme separately from transmitting a MIMO transmission as described with regard to reference number 650, the transmitter 602 may transmit the indication of the quasi-orthogonal SC-MIMO-based mapping scheme in the MIMO transmission or as part of the MIMO transmission. In other examples, the transmitter may not transmit an indication of the quasi-orthogonal SC-MIMO-based mapping scheme and/or may not indicate that a MIMO transmission uses the quasi-orthogonal SC-MIMO-based mapping scheme.

As shown by reference number 650, the transmitter 602 may transmit, and the receiver 604 may receive, the MIMO transmission, where the MIMO transmission includes N layers. For instance, the transmitter 602 may transmit the separate layers of the MIMO transmission based at least in part on spatial multiplexing as described above. The MIMO transmission may carry one or more codewords that are mapped using a quasi-orthogonal SC-MIMO-based mapping scheme.

As shown by reference number 660, the receiver 604 may decode the MIMO transmission using a quasi-orthogonal SC-MIMO-based mapping scheme, such as a quasi-orthogonal SC-MIMO-based mapping scheme as described with regard to reference number 630 and FIG. 5. For instance, the receiver 604 may use SIC as at least part of a decoding procedure based at least in part on orthogonal code block pairings as described above.

For scenarios in which N is equal or greater than four, the MIMO transmission may include a first set of code blocks that are associated with a first codeword and a second set of code blocks that are associated with a second codeword. In one example, to decode the MIMO transmission, the receiver 604 may decode the first set of code blocks using an expectation that the first set of code blocks are mapped across a first pair of layers (or a first pair of layer groups) using the quasi-orthogonal SC-MIMO-based mapping scheme. Alternatively, or additionally, the receiver 604 may decode the second set of code blocks using an expectation that the second set of code blocks are mapped across a second pair of layers (or a second pair of layer groups) using the quasi-orthogonal SC-MIMO-based mapping scheme and independent from the first set of code blocks. Accordingly, the receiver 604 may decode the first set of code blocks independently from the second set of code blocks. In a second example, to decode the MIMO transmission, the receiver 604 may decode the first set of code blocks based at least in part on the first set of code blocks being mapped across the N layers using the quasi-orthogonal SC-MIMO-based mapping scheme and a first subset of time-frequency resources that are allocated to the MIMO transmission, and the second set of code blocks based at least in part on the second set of code blocks being mapped across the N layers using the quasi-orthogonal SC-MIMO-based mapping scheme and a second subset of time-frequency resources that are allocated to the MIMO transmission.

A quasi-orthogonal SC-MIMO-based mapping scheme may be applicable to a larger quantity of operating scenarios (e.g., equal code block sizes in addition to unequal code block sizes) and/or a larger quantity of UEs (e.g., UEs that support parallel decoding and UEs that do not support parallel decoding) relative to using an SC-MIMO-based mapping scheme that does not use the layer-based cyclical shift. The increased applicability and usage of quasi-orthogonal SC-MIMO may increase a robustness, increase a reliability, and/or increase data throughput for LDPC-based MIMO transmissions.

As indicated above, FIG. 6 is provided as an example. Other examples may differ from what is described with regard to FIG. 6.

FIG. 7 is a diagram illustrating an example process 700 performed, for example, at a transmitter or an apparatus of a transmitter. Example process 700 is an example where the apparatus or the transmitter (e.g., a UE 120 or a network node 110) performs operations associated with quasi-orthogonal SC-MIMO.

As shown in FIG. 7, in some aspects, process 700 may include generating multiple code blocks based at least in part on a TB segmentation procedure (block 710). For example, the transmitter (e.g., using communication manager 906, depicted in FIG. 9 for a UE and using communication manager 1006, depicted in FIG. 10 for a network node) may generate multiple code blocks based at least in part on a TB segmentation procedure, as described above.

As further shown in FIG. 7, in some aspects, process 700 may include mapping the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer (block 720). For example, the transmitter (e.g., using communication manager 906, depicted in FIG. 9 for a UE and using communication manager 1006, depicted in FIG. 10 for a network node) may map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer, as described above.

As further shown in FIG. 7, in some aspects, process 700 may include transmitting the MIMO transmission based at least in part on the quasi-orthogonal SC-MIMO-based mapping scheme (block 730). For example, the transmitter (e.g., using transmission component 904 or communication manager 906, depicted in FIG. 9 for a UE and using transmission component 1004 or communication manager 1006, depicted in FIG. 10 for a network node) may transmit the MIMO transmission based at least in part on the quasi-orthogonal SC-MIMO-based mapping scheme, as described above.

Process 700 may include additional aspects, such as any single aspect or any combination of aspects described below or in connection with one or more other processes described elsewhere herein.

In a first aspect, the layer-based cyclical shift includes a layer-dependent cyclical shift or a layer-group-dependent cyclical shift.

In a second aspect, the layer-based cyclic shift includes an RE shift that is based at least in part on a respective integer multiple of a shift value.

In a third aspect, the layer-based cyclic shift is within an OFDM symbol.

In a fourth aspect, the shift value is a constant value.

In a fifth aspect, the shift value is derived from at least one of a TB size or a code block size.

In a sixth aspect, the quasi-orthogonal SC-MIMO-based mapping scheme is based at least in part on a group of MIMO layers, and the quasi-orthogonal SC-MIMO-based mapping scheme includes an interference-mitigating code block at a decoding start location in at least one MIMO layer in the group of MIMO layers.

In a seventh aspect, the decoding start location is a first code block location.

In an eighth aspect, the N layers include at least four layers, the multiple code blocks include at least a first set of code blocks that are associated with a first codeword and a second set of code blocks that are associated with a second codeword, and the N layers are grouped into at least a first pair of layers and a second pair of layers. Mapping the multiple code blocks across the N layers of the MIMO transmission includes mapping the first set of code blocks that are associated with the first codeword across the first pair of layers using the quasi-orthogonal SC-MIMO-based mapping scheme and mapping the second set of code blocks that are associated with the second codeword across the second pair of layers using the quasi-orthogonal SC-MIMO-based mapping scheme, where mapping the second set of code blocks is independent from mapping the first set of code blocks.

In a ninth aspect, the N layers include at least four layers, and the multiple code blocks are based at least in part on a first set of code blocks that are associated with a first codeword and a second set of code blocks that are associated with a second codeword. Mapping the multiple code blocks across the N layers of the MIMO transmission includes mapping the first set of code blocks across the N layers of the MIMO transmission based at least in part on a first subset of time-frequency resources, and mapping the second set of code blocks that are associated with the second codeword across the N layers of the MIMO transmission based at least in part on a second subset of time-frequency resources that are different from the first subset of time-frequency resources.

In a tenth aspect, the TB segmentation procedure does not guarantee each code block of the multiple code blocks has a same size.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a receiver or an apparatus of a receiver. Example process 800 is an example where the apparatus or the receiver (e.g., a UE 120 or a network node 110) performs operations associated with quasi-orthogonal SC-MIMO.

As shown in FIG. 8, in some aspects, process 800 may include receiving a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers, N being an integer (block 810). For example, the receiver (e.g., using reception component 902 or communication manager 906, depicted in FIG. 9 for a UE and using reception component 1002 or communication manager 1006, depicted in FIG. 10 for a network node) may receive a MIMO transmission that includes N layers, the MIMO transmission being based at least in part on a quasi-orthogonal SC-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers, N being an integer, as described above.

As further shown in FIG. 8, in some aspects, process 800 may include decoding the MIMO transmission based at least in part on the quasi-orthogonal SC-MIMO-based mapping scheme (block 820). For example, the receiver (e.g., using communication manager 906, depicted in FIG. 9 for a UE and using communication manager 1006, depicted in FIG. 10 for a network node) may decode the MIMO transmission based at least in part on the quasi-orthogonal SC-MIMO-based mapping scheme, as described above.

Process 800 may include additional aspects, such as any single aspect or any combination of aspects described below or in connection with one or more other processes described elsewhere herein.

In a first aspect, the layer-based cyclical shift includes a layer-dependent cyclical shift, or a layer-group-dependent cyclical shift.

In a second aspect, the layer-based cyclic shift includes a resource element shift that is based at least in part on a respective integer multiple of a shift value.

In a third aspect, the shift value is a constant value.

In a fourth aspect, the shift value is derived from at least one of a TB size, or a code block size.

In a fifth aspect, the quasi-orthogonal SC-MIMO-based mapping scheme is based at least in part on a group of MIMO layers, and the quasi-orthogonal SC-MIMO-based mapping scheme includes an interference-mitigating code block at a decoding start location in at least one MIMO layer in the group of MIMO layers.

In a sixth aspect, the decoding start location is a first code block location.

In a seventh aspect, the quasi-orthogonal SC-MIMO-based mapping scheme is based at least in part on a group of MIMO layers, decoding the MIMO transmission includes decoding the MIMO transmission based at least in part on using an SC-MIMO-based mapping scheme that specifies an interference-mitigating code block at a decoding start location in at least one MIMO layer in the group of MIMO layers, and the MIMO transmission does not include the interference-mitigating code block.

In an eighth aspect, the quasi-orthogonal SC-MIMO-based mapping scheme is based at least in part on a group of MIMO layers, decoding the MIMO transmission includes decoding a first code block in the MIMO transmission successfully, and decoding a remainder of the MIMO transmission based at least in part on using an SC-MIMO-based mapping scheme and successive interference cancellation.

In a ninth aspect, the N layers include at least four layers, the multiple code blocks include at least a first set of code blocks that are associated with a first codeword and a second set of code blocks that are associated with a second codeword, and the N layers are grouped into at least a first pair of layers and a second pair of layers. As part of the ninth aspect, decoding the MIMO transmission includes decoding the first set of code blocks associated with the first codeword based at least in part on the first set of code blocks being mapped across the first pair of layers using the quasi-orthogonal SC-MIMO-based mapping scheme, and decoding the second set of code blocks that are associated with the second codeword based at least in part on the second set of code blocks being mapped across the second pair of layers using the quasi-orthogonal SC-MIMO-based mapping scheme, where decoding the second set of code blocks is independent from decoding the first set of code blocks.

In a tenth aspect, the N layers include at least four layers, the multiple code blocks are based at least in part on a first set of code blocks that are associated with a first codeword and a second set of code blocks that are associated with a second codeword. As part of the tenth aspect, decoding the MIMO transmission includes decoding the first set of code blocks associated with the first codeword based at least in part on the first set of code blocks being mapped across the N layers of the MIMO transmission using the quasi-orthogonal SC-MIMO-based mapping scheme and a first subset of time-frequency resources that are allocated to the MIMO transmission, and decoding the second set of code blocks associated with the second codeword based at least in part on the second set of code blocks being mapped across the N layers of the MIMO transmission using the quasi-orthogonal SC-MIMO-based mapping scheme and a second subset of time-frequency resources that are allocated to the MIMO transmission.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE 120, or a UE 120 may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the transmitter.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, process 800 of FIG. 8, or a combination thereof. In some aspects, the apparatus 900 or one or more components shown in FIG. 9 may include one or more components of the transmitter described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the transmitter described above in connection with FIG. 1, such as a radio, one or more RF chains, one or more transceivers, or one or more modems, each of which may in turn be coupled with one or more antennas of the transmitter.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

Based at least in part on the UE being a transmitter, the communication manager 906 may generate multiple code blocks based at least in part on a TB segmentation procedure. The communication manager 906 may map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer. The transmission component 904 may transmit the MIMO transmission based at least in part on the quasi-orthogonal SC-MIMO-based mapping scheme.

Alternatively, or additionally, based at least in part on the UE being a receiver, the reception component 902 may receive a MIMO transmission that includes N layers, the MIMO transmission being based at least in part on a quasi-orthogonal SC-MIMO-based mapping scheme that is based at least in part on multiple code blocks being mapped across the N layers such that each layer of the N layers includes a respective portion of the multiple code blocks, and a layer-based cyclical shift of the respective portion of the multiple code blocks for one or more layers of the N layers, N being an integer. The communication manager 906 may decode the MIMO transmission based at least in part on the quasi-orthogonal SC-MIMO-based mapping scheme.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node (e.g., a network node 110), or a network node (e.g., a network node 110) may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the receiver.

In some aspects, the apparatus 1000 may be configured to perform one or more operations described herein in connection with FIGS. 4-6. Additionally, or alternatively, the apparatus 1000 may be configured to perform one or more processes described herein, such as process 700 of FIG. 7, process 800 of FIG. 8, or a combination thereof. In some aspects, the apparatus 1000 or one or more components shown in FIG. 10 may include one or more components of the receiver described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the receiver described above in connection with FIG. 1, such as a radio, one or more RF chains, one or more transceivers, or one or more modems, each of which may in turn be coupled with one or more antennas of the receiver.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

Based at least in part on the network node being a transmitter, the communication manager 1006 may generate multiple code blocks based at least in part on a TB segmentation procedure. The communication manager 1006 may map the multiple code blocks across N layers of a MIMO transmission such that each layer of the N layers is assigned a respective portion of the multiple code blocks, the mapping being based at least in part on a quasi-orthogonal SC-MIMO-based mapping scheme that includes a layer-based cyclical shift of the respective portion of the multiple code blocks for one or more layers of the N layers, N being an integer. The transmission component 1004 may transmit the MIMO transmission based at least in part on the quasi-orthogonal SC-MIMO-based mapping scheme.

Alternatively, or additionally, based at least in part on the network node being a receiver, the reception component 1002 may receive a MIMO transmission that includes N layers, the MIMO transmission being based at least in part on a quasi-orthogonal SC-MIMO-based mapping scheme that is based at least in part on multiple code blocks being mapped across the N layers such that each layer of the N layers includes a respective portion of the multiple code blocks, and a layer-based cyclical shift of the respective portion of the multiple code blocks for one or more layers of the N layers, N being an integer. The communication manager 1006 may decode the MIMO transmission based at least in part on the quasi-orthogonal SC-MIMO-based mapping scheme.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a transmitter, comprising: generating multiple code blocks based at least in part on a transport block (TB) segmentation procedure; mapping the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer; and transmitting the MIMO transmission based at least in part on the quasi-orthogonal SC-MIMO-based mapping scheme.

Aspect 2: The method of Aspect 1, wherein the layer-based cyclical shift comprises: a layer-dependent cyclical shift, or a layer-group-dependent cyclical shift.

Aspect 3: The method of any of Aspects 1-2, wherein the layer-based cyclic shift comprises a resource element (RE) shift that is based at least in part on a respective integer multiple of a shift value.

Aspect 4: The method of Aspect 3, wherein the layer-based cyclic shift is within an orthogonal frequency division multiplex (OFDM) symbol.

Aspect 5: The method of Aspect 3 or Aspect 4, wherein the shift value is a constant value.

Aspect 6: The method of Aspect 3 or Aspect 4, wherein the shift value is derived from at least one of: a TB size, or a code block size.

Aspect 7: The method of any of Aspects 1-6, wherein the quasi-orthogonal SC-MIMO-based mapping scheme is based at least in part on a group of MIMO layers, and wherein the quasi-orthogonal SC-MIMO-based mapping scheme comprises inclusion of an interference-mitigating code block at a decoding start location in at least one MIMO layer in the group of MIMO layers.

Aspect 8: The method of Aspect 7, wherein the decoding start location is a first code block location.

Aspect 9: The method of any of Aspects 1-8, wherein the N layers include at least four layers, wherein the multiple code blocks comprise at least a first set of code blocks that are associated with a first codeword and a second set of code blocks that are associated with a second codeword, wherein the N layers are grouped into at least a first pair of layers and a second pair of layers, and wherein mapping the multiple code blocks across the N layers of the MIMO transmission comprises: mapping the first set of code blocks that are associated with the first codeword across the first pair of layers using the quasi-orthogonal SC-MIMO-based mapping scheme; and mapping the second set of code blocks that are associated with the second codeword across the second pair of layers using the quasi-orthogonal SC-MIMO-based mapping scheme, wherein mapping the second set of code blocks is independent from mapping the first set of code blocks.

Aspect 10: The method of any of Aspects 1-9, wherein the N layers include at least four layers, wherein the multiple code blocks are based at least in part on a first set of code blocks that are associated with a first codeword and a second set of code blocks that are associated with a second codeword, and wherein mapping the multiple code blocks across the N layers of the MIMO transmission comprises: mapping the first set of code blocks across the N layers of the MIMO transmission based at least in part on a first subset of time-frequency resources; and mapping the second set of code blocks that are associated with the second codeword across the N layers of the MIMO transmission based at least in part on a second subset of time-frequency resources that are different from the first subset of time-frequency resources.

Aspect 11: The method of any of Aspects 1-10, wherein the TB segmentation procedure does not guarantee each code block of the multiple code blocks has a same size.

Aspect 12: A method of wireless communication performed by a receiver, comprising: receiving a multiple-input, multiple-output (MIMO) transmission that includes N layers, the MIMO transmission being based at least in part on a quasi-orthogonal spatially-coupled (SC)-MIMO-based mapping scheme that is based at least in part on: multiple code blocks being mapped across the N layers such that each layer of the N layers includes a respective portion of the multiple code blocks, and a layer-based cyclical shift of the respective portion of the multiple code blocks for one or more layers of the N layers, N being an integer; and decoding the MIMO transmission based at least in part on the quasi-orthogonal SC-MIMO-based mapping scheme.

Aspect 13: The method of Aspect 12, wherein the layer-based cyclical shift comprises: a layer-dependent cyclical shift, or a layer-group-dependent cyclical shift.

Aspect 14: The method of any of Aspects 12-13, wherein the layer-based cyclic shift comprises a resource element shift that is based at least in part on a respective integer multiple of a shift value.

Aspect 15: The method of Aspect 14, wherein the shift value is a constant value.

Aspect 16: The method of Aspect 14, wherein the shift value is derived from at least one of: a TB size, or a code block size.

Aspect 17: The method of any of Aspects 12-16, wherein the quasi-orthogonal SC-MIMO-based mapping scheme is based at least in part on a group of MIMO layers, and wherein the quasi-orthogonal SC-MIMO-based mapping scheme comprises inclusion of an interference-mitigating code block at a decoding start location in at least one MIMO layer in the group of MIMO layers.

Aspect 18: The method of Aspect 17, wherein the decoding start location is a first code block location.

Aspect 19: The method of any of Aspects 12-18, wherein the quasi-orthogonal SC-MIMO-based mapping scheme is based at least in part on a group of MIMO layers, and wherein decoding the MIMO transmission comprises: decoding the MIMO transmission based at least in part on using an SC-MIMO-based mapping scheme that specifies an interference-mitigating code block at a decoding start location in at least one MIMO layer in the group of MIMO layers, wherein the MIMO transmission does not include the interference-mitigating code block.

Aspect 20: The method of any of Aspects 12-19, wherein the quasi-orthogonal SC-MIMO-based mapping scheme is based at least in part on a group of MIMO layers, and wherein decoding the MIMO transmission comprises: decoding a first code block in the MIMO transmission successfully; and decoding a remainder of the MIMO transmission based at least in part on using an SC-MIMO-based mapping scheme and successive interference cancellation.

Aspect 21: The method of any of Aspects 12-20, wherein the N layers include at least four layers, wherein the multiple code blocks comprise at least a first set of code blocks that are associated with a first codeword and a second set of code blocks that are associated with a second codeword, wherein the N layers are grouped into at least a first pair of layers and a second pair of layers, and wherein decoding the MIMO transmission comprises: decoding the first set of code blocks associated with the first codeword based at least in part on the first set of code blocks being mapped across the first pair of layers using the quasi-orthogonal SC-MIMO-based mapping scheme; and decoding the second set of code blocks that are associated with the second codeword based at least in part on the second set of code blocks being mapped across the second pair of layers using the quasi-orthogonal SC-MIMO-based mapping scheme, the decoding the second set of code blocks being independent from decoding the first set of code blocks.

Aspect 22: The method of any of Aspects 12-21, wherein the N layers include at least four layers, wherein the multiple code blocks are based at least in part on a first set of code blocks that are associated with a first codeword and a second set of code blocks that are associated with a second codeword, and wherein decoding the MIMO transmission comprises: decoding the first set of code blocks associated with the first codeword based at least in part on the first set of code blocks being mapped across the N layers of the MIMO transmission using the quasi-orthogonal SC-MIMO-based mapping scheme and a first subset of time-frequency resources that are allocated to the MIMO transmission; and decoding the second set of code blocks associated with the second codeword based at least in part on the second set of code blocks being mapped across the N layers of the MIMO transmission using the quasi-orthogonal SC-MIMO-based mapping scheme and a second subset of time-frequency resources that are allocated to the MIMO transmission.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 24: An apparatus for wireless communication at a device, the apparatus comprising one or more memories and one or more processors coupled to the one or more memories, the one or more processors configured to cause the device to perform the method of one or more of Aspects 1-11.

Aspect 25: An apparatus for wireless communication, the apparatus comprising at least one means for performing the method of one or more of Aspects 1-11.

Aspect 26: A non-transitory computer-readable medium storing code for wireless communication, the code comprising instructions executable by one or more processors to perform the method of one or more of Aspects 1-11.

Aspect 27: A non-transitory computer-readable medium storing a set of instructions for wireless communication, the set of instructions comprising one or more instructions that, when executed by one or more processors of a device, cause the device to perform the method of one or more of Aspects 1-11.

Aspect 28: A device for wireless communication, the device comprising a processing system that includes one or more processors and one or more memories coupled with the one or more processors, the processing system configured to cause the device to perform the method of one or more of Aspects 1-11.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 30: A device comprising a processing system that includes one or more processors and one or more code-storing memories coupled with the one or more processors, the processing system configured to cause the device to perform the method of one or more of Aspects 1-11.

Aspect 31: A device comprising a processing system that includes processor circuitry and code-storing memory circuitry, the processing system configured to cause the device to perform the method of one or more of Aspects 1-11.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-22.

Aspect 33: An apparatus for wireless communication at a device, the apparatus comprising one or more memories and one or more processors coupled to the one or more memories, the one or more processors configured to cause the device to perform the method of one or more of Aspects 12-22.

Aspect 34: An apparatus for wireless communication, the apparatus comprising at least one means for performing the method of one or more of Aspects 12-22.

Aspect 35: A non-transitory computer-readable medium storing code for wireless communication, the code comprising instructions executable by one or more processors to perform the method of one or more of Aspects 12-22.

Aspect 36: A non-transitory computer-readable medium storing a set of instructions for wireless communication, the set of instructions comprising one or more instructions that, when executed by one or more processors of a device, cause the device to perform the method of one or more of Aspects 12-22.

Aspect 37: A device for wireless communication, the device comprising a processing system that includes one or more processors and one or more memories coupled with the one or more processors, the processing system configured to cause the device to perform the method of one or more of Aspects 12-22.

Aspect 38: An apparatus for wireless communication at a device, the apparatus comprising one or more memories and one or more processors coupled to the one or more memories, the one or more processors individually or collectively configured to cause the device to perform the method of one or more of Aspects 12-22.

Aspect 39: A device comprising a processing system that includes one or more processors and one or more code-storing memories coupled with the one or more processors, the processing system configured to cause the device to perform the method of one or more of Aspects 12-22.

Aspect 40: A device comprising a processing system that includes processor circuitry and code-storing memory circuitry, the processing system configured to cause the device to perform the method of one or more of Aspects 12-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter, comprising:
a processing system that includes processor circuitry and code-storing memory circuitry, the processing system configured to cause the transmitter to:
generate multiple code blocks based at least in part on a transport block (TB) segmentation procedure;
map the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer; and
transmit the MIMO transmission based at least in part on the quasi-orthogonal SC-MIMO-based mapping scheme.

2. The transmitter of claim 1, wherein the layer-based cyclical shift comprises:
a layer-dependent cyclical shift, or
a layer-group-dependent cyclical shift.

3. The transmitter of claim 1, wherein the layer-based cyclic shift comprises a resource element (RE) shift that is based at least in part on a respective integer multiple of a shift value.

4. The transmitter of claim 3, wherein the layer-based cyclic shift is within an orthogonal frequency division multiplex (OFDM) symbol.

5. The transmitter of claim 3, wherein the shift value is a constant value.

6. The transmitter of claim 3, wherein the shift value is derived from at least one of:
a TB size, or
a code block size.

7. The transmitter of claim 1, wherein the quasi-orthogonal SC-MIMO-based mapping scheme is based at least in part on a group of MIMO layers, and wherein the quasi-orthogonal SC-MIMO-based mapping scheme comprises inclusion of an interference-mitigating code block at a decoding start location in at least one MIMO layer in the group of MIMO layers.

8. The transmitter of claim 1, wherein the N layers include at least four layers,
wherein the multiple code blocks comprise at least a first set of code blocks that are associated with a first codeword and a second set of code blocks that are associated with a second codeword,
wherein the N layers are grouped into at least a first pair of layers and a second pair of layers, and
wherein the processing system, to cause the transmitter to map the multiple code blocks across the N layers of the MIMO transmission, is configured to cause the transmitter to:
map the first set of code blocks that are associated with the first codeword across the first pair of layers using the quasi-orthogonal SC-MIMO-based mapping scheme; and
map the second set of code blocks that are associated with the second codeword across the second pair of layers using the quasi-orthogonal SC-MIMO-based mapping scheme, wherein mapping the second set of code blocks is independent from mapping the first set of code blocks.

9. The transmitter of claim 1, wherein the N layers include at least four layers,
wherein the multiple code blocks are based at least in part on a first set of code blocks that are associated with a first codeword and a second set of code blocks that are associated with a second codeword, and
wherein the processing system, to cause the transmitter to map the multiple code blocks across the N layers of the MIMO transmission, is configured to cause the transmitter to:
map the first set of code blocks across the N layers of the MIMO transmission based at least in part on a first subset of time-frequency resources; and
map the second set of code blocks that are associated with the second codeword across the N layers of the MIMO transmission based at least in part on a second subset of time-frequency resources that are different from the first subset of time-frequency resources.

10. The transmitter of claim 1, wherein the TB segmentation procedure does not guarantee each code block of the multiple code blocks has a same size.

11. A method of wireless communication performed by a transmitter, comprising:
generating multiple code blocks based at least in part on a transport block (TB) segmentation procedure;
mapping the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer; and
transmitting the MIMO transmission based at least in part on the quasi-orthogonal SC-MIMO-based mapping scheme.

12. The method of claim 11, wherein the layer-based cyclical shift comprises:
a layer-dependent cyclical shift, or
a layer-group-dependent cyclical shift.

13. The method of claim 12, wherein the layer-based cyclic shift is within an orthogonal frequency division multiplex (OFDM) symbol.

14. The method of claim 11, wherein the quasi-orthogonal SC-MIMO-based mapping scheme is based at least in part on a group of MIMO layers, and
wherein the quasi-orthogonal SC-MIMO-based mapping scheme comprises inclusion of an interference-mitigating code block at a decoding start location in at least one MIMO layer in the group of MIMO layers.

15. The method of claim 11, wherein the N layers include at least four layers,
wherein the multiple code blocks comprise at least a first set of code blocks that are associated with a first codeword and a second set of code blocks that are associated with a second codeword,
wherein the N layers are grouped into at least a first pair of layers and a second pair of layers, and
wherein mapping the multiple code blocks across the N layers of the MIMO transmission comprises:
mapping the first set of code blocks that are associated with the first codeword across the first pair of layers using the quasi-orthogonal SC-MIMO-based mapping scheme; and
mapping the second set of code blocks that are associated with the second codeword across the second pair of layers using the quasi-orthogonal SC-MIMO-based mapping scheme, wherein mapping the second set of code blocks is independent from mapping the first set of code blocks.

16. The method of claim 11, wherein the N layers include at least four layers,
wherein the multiple code blocks are based at least in part on a first set of code blocks that are associated with a first codeword and a second set of code blocks that are associated with a second codeword, and
wherein mapping the multiple code blocks across the N layers of the MIMO transmission comprises:
mapping the first set of code blocks across the N layers of the MIMO transmission based at least in part on a first subset of time-frequency resources; and
mapping the second set of code blocks that are associated with the second codeword across the N layers of the MIMO transmission based at least in part on a second subset of time-frequency resources that are different from the first subset of time-frequency resources.

17. A non-transitory computer-readable medium storing a set of instructions for wireless communication, the set of instructions comprising:
one or more instructions that, when executed by one or more processors of a transmitter, cause the transmitter to:
generate multiple code blocks based at least in part on a transport block (TB) segmentation procedure;
map the multiple code blocks across N layers of a multiple-input, multiple-output (MIMO) transmission such that each layer of the N layers is assigned a respective portion of the multiple code blocks, the mapping being based at least in part on a quasi-orthogonal spatially-coupled (SC)-MIMO-based mapping scheme that includes a layer-based cyclical shift of the respective portion of the multiple code blocks for one or more layers of the N layers, N being an integer; and
transmit the MIMO transmission based at least in part on the quasi-orthogonal SC-MIMO-based mapping scheme.

18. The non-transitory computer-readable medium of claim 17, wherein the layer-based cyclical shift comprises:
a layer-dependent cyclical shift, or
a layer-group-dependent cyclical shift.

19. The non-transitory computer-readable medium of claim 17, wherein the quasi-orthogonal SC-MIMO-based mapping scheme is based at least in part on a group of MIMO layers, and
wherein the quasi-orthogonal SC-MIMO-based mapping scheme comprises inclusion of an interference-mitigating code block at a decoding start location in at least one MIMO layer in the group of MIMO layers.

20. The non-transitory computer-readable medium of claim 17, wherein the N layers include at least four layers,
wherein the multiple code blocks comprise at least a first set of code blocks that are associated with a first codeword and a second set of code blocks that are associated with a second codeword,
wherein the N layers are grouped into at least a first pair of layers and a second pair of layers, and
wherein the one or more instructions, that cause the transmitter to map the multiple code blocks across the N layers of the MIMO transmission, cause the transmitter to:
map the first set of code blocks that are associated with the first codeword across the first pair of layers using the quasi-orthogonal SC-MIMO-based mapping scheme; and
map the second set of code blocks that are associated with the second codeword across the second pair of layers using the quasi-orthogonal SC-MIMO-based mapping scheme, wherein mapping the second set of code blocks is independent from mapping the first set of code blocks.
